(19) United States
(12) Patent Application Publication
(10) Pub. No.: US 2012/0113977 A1
(43) Pub. Date: May 10, 2012

(54) VPN DEVICE AND VPN NETWORKING METHOD

(75) Inventors: Hiroyuki Shimoosawa, Fukuoka (JP); Akira Miyajima, Fukuoka (JP); Yasuhiro Kato, Kanagawa (JP); Syusuke Terado, Kanagawa (JP); Reiko Mori, Kanagawa (JP)

(73) Assignee: PANASONIC CORPORATION, Osaka (JP)

(21) Appl. No.: 13/264,313

(22) PCT Filed: Apr. 16, 2010
(86) PCT No.: PCT/JP2010/002799

§ 371 Date: Jan. 26, 2012

(30) Foreign Application Priority Data
Apr. 16, 2009 (JP) 2009099965
Apr. 20, 2009 (JP) 2009102108
Jun. 8, 2009 (JP) 2009137423
Jun. 8, 2009 (JP) 2009137424

(51) Int. Cl. H04L 12/66

(52) U.S. Cl. 370/352

(57) ABSTRACT

A VPN device capable of eliminating situations where cross calls occur is provided. The VPN device includes: an identification information acquisition unit that acquires first identification information which is identification information of a communication terminal (103) and second identification information which is identification information of a communication terminal (303); a priority determination unit that determines the priority for initiating a session between the communication terminal (103) and the communication terminal (303) based on the first and second identification information; a message type generation unit that designates the type of a message relating to call control to be transmitted to the communication terminal (303) based on the priority; and a transmission unit that transmits a message of the designated type to the communication terminal (303).

### TECHNICAL FIELD

The invention relates to a VPN device and a VPN networking method, and more particularly, to a technique of establishing a VPN (Virtual Private Network) between terminals on different networks to perform peer-to-peer (hereinafter referred to as P2P) communication.

### BACKGROUND ART

In general, a virtual private network (hereinafter referred to as a VPN) connects different network segments such as local area networks (LANs) at two or more locations, for example, in a company or the like through a wide area network (WAN) or the like. Then, confidentiality of communication is ensured, whereby virtually the whole network serves as one private network. In this way, it is possible to provide the same communication service as when using leased lines.

When establishing a VPN, a network relay device or a VPN device provided in communication terminals or the like (hereinafter, these terminals will be referred to as “peers”) encrypts and encapsulates packets to establish virtual tunnels. In this way, a closed virtual direct communication (hereinafter referred to as “P2P (Peer-to-Peer) communication”) channel that connects peers is established.

As examples of a system for performing P2P communication, a hybrid P2P system which includes a server (hereinafter referred to as an index server) for assisting in establishing a session between peers, a supernode P2P system in which an index server is not provided in a hybrid P2P system, but a specific number of peers perform the role of an index server are known.

In these systems, a method of using a call control server as a way for discovering a communication counterpart is known as the techniques of the index server. The call control server performs control of establishing a session between communication devices using a call control establishment technique defined in a SIP (Session Initiation Protocol). When performing call control establishment using SIP, a method is generally performed in which a caller-side communication device transmits an INVITE message (call message) to a callee-side communication device, the callee-side communication device having received the INVITE message transmits an OK message (call-receipt message) to the caller-side communication device, and the caller-side communication device having received the OK message transmits an ACK message (call-receipt acknowledgement message) to the callee-side communication device, whereby a session is established. This procedure of call control process is referred to as a 3-way hand shake (hereinafter referred to as 3WHS). After the session is established in this way, P2P communication is performed to transmit and receive files.

As an example of such a 3WHS procedure, a technique in which another call control process is performed in parallel after the INVITE message is transmitted so as to quickly initiate communication is known (for example, see Patent Literature 1).

### Citation List

### Patent Literature

Patent Literature 1: JP-A-2006-345407

### SUMMARY OF INVENTION

### Technical Problem

However, the respective peers in P2P communication may transmit their call messages at the same time (which may involve short time lag) in order to establish a session. In this case, since both peers receive call messages despite the fact that they have transmitted call messages, the respective peers determine this situation as an irregular process. For example, in the case of a telephone application, since mutual peers transmit call messages at the same time, and the counterpart peers thereof receive the call messages at the same time, the respective peers are determined to be in the busy state and enter into a standby state. This state is referred to as a cross call, and a session will not be established indefinitely since the calling process will be continued unless a certain irregular canceling process is performed.

The present invention has been made in view of the above problems, and an object of the invention is to provide a VPN device and a VPN networking method capable of eliminating situations where cross calls occur.

### Solution to Problem

The invention corresponds to a VPN device to be provided on a first network for performing a P2P communication between a first terminal provided on the first network and a second terminal provided on a second network connected to the first network, the VPN device including: a priority determination unit that determines which one of the first terminal and the second terminal has a higher priority of a call; and a transmission unit that transmits a call message to the second network to call the second terminal when the priority determination unit has determined that the first terminal has the higher priority than the second terminal, and that transmits a call request message to the second network to request a call from the second terminal when the priority determination unit has determined that the second terminal has the higher priority than the first terminal.

According to the invention, the priority of the calls made by first and second terminals is determined, and a call message or a call request message is transmitted in accordance with the determination result. Therefore, it is possible to provide a VPN device capable of eliminating situations where cross calls occur while preventing the first and second terminals from transmitting their call messages.

### Advantageous Effects of Invention

According to the invention, it is possible to eliminate situations where cross calls occur.

### BRIEF DESCRIPTION OF DRAWINGS

FIG. 1 is a diagram showing a configuration example of a VPN system according to a first embodiment of the invention.

FIG. 2 is a block diagram showing a configuration example of a hardware configuration of a VPN device of the first embodiment of the invention.

FIG. 3 is a block diagram showing a functional configuration example of the VPN device of the first embodiment of the invention.

FIG. 4 is a sequence diagram showing a process procedure when the VPN system of the first embodiment of the invention establishes a VPN.

FIG. 5 is a flowchart showing the processing details when the VPN device of the first embodiment of the invention establishes a VPN.

FIG. 6 is a flowchart showing the processing details of an external address information acquisition process in the first embodiment of the invention.

FIG. 7 is a sequence diagram showing a processing procedure of an external address and port acquisition request in the first embodiment of the invention.

FIG. 8 is a diagram showing the packet structures of the external address and port acquisition request and an external address and port information response in the first embodiment of the invention.

FIG. 9 is a diagram showing the packet structures during VPN communication in the first embodiment of the invention.

FIG. 10 is a diagram showing a state transition of a UDP hole punching operation in the first embodiment of the invention.

FIG. 11 is a sequence diagram showing a processing procedure when a VPN system of a second embodiment of the invention establishes a VPN.

FIG. 12 is a sequence diagram showing another processing procedure when the VPN system of the second embodiment of the invention establishes a VPN.

FIG. 13 is a flowchart showing the processing details when a VPN device of the second embodiment of the invention established a VPN.

FIG. 14 is a flowchart showing another processing details when the VPN device of the second embodiment of the invention establishes a VPN.

FIG. 15 is a diagram showing a modified configuration example of the VPN system according to the second embodiment of the invention.

FIG. 16 is a block diagram showing a functional modified configuration example of the VPN device of the second embodiment of the invention.

FIG. 17 is a diagram showing a configuration example of a VPN system according to a third embodiment of the invention.

FIG. 18 is a diagram showing an example of communication (local P2P communication) performed between VPN devices connected to the same LAN in the third embodiment of the invention.

FIG. 19 is a diagram showing an example of an environment in which routers are arranged in multiple stages within the same LAN in the third embodiment of the invention.

FIG. 20 is a block diagram showing a configuration example of a hardware configuration of the VPN device of the third embodiment of the invention.

FIG. 21 is a block diagram showing a functional configuration example of the VPN device of the third embodiment of the invention.

FIG. 22 is a diagram showing an example of communication channel information stored by a communication channel information storage unit of the VPN device of the third embodiment of the invention.

FIG. 23 is a sequence diagram showing an example of a processing procedure when the VPN system of the third embodiment of the invention establishes a VPN.

FIG. 24 is a flowchart showing an example of the processing details when the VPN device of the third embodiment of the invention establishes a VPN.

FIG. 25 is a flowchart showing an example of the processing details when the VPN device of the third embodiment of the invention establishes a VPN.

FIG. 26 is a diagram showing an example of a configuration of a communication system according to a fourth embodiment of the invention.

FIG. 27 is a diagram showing an example of a hardware configuration of a VPN device according to the fourth embodiment of the invention.

FIG. 28 is a diagram showing an example of a functional configuration of the VPN device of the fourth embodiment of the invention.

FIG. 29 is a diagram showing an example of a communication procedure when a communication terminal with high priority makes a call to a communication terminal with low priority in the fourth embodiment of the invention.

FIG. 30 is a diagram showing an example of a communication procedure when a communication terminal with low priority makes a call to a communication terminal with high priority in the fourth embodiment of the invention.

FIG. 31 is a diagram showing an example of a communication procedure when a communication terminal with high priority and a communication terminal with low priority make calls at the same time in the fourth embodiment of the invention.

FIG. 32 is a flowchart showing an example of operations when the VPN device of the fourth embodiment of the invention relays communication between a communication terminal and a destination communication terminal being served by the VPN device.

FIG. 33 is a diagram showing an example of a configuration of a communication system according to a fifth embodiment of the invention.

FIG. 34 is a diagram showing an example of a hardware configuration of a VPN device of the fifth embodiment of the invention.

FIG. 35 is a diagram showing an example of a functional configuration of the VPN device of the fifth embodiment of the invention.

FIG. 36 is a flowchart showing an example of operations when a communication terminal of the fifth embodiment of the invention initiates a session.

### MODE FOR CARRYING OUT INVENTION

Hereinafter, embodiments of a VPN device, a VPN networking method, and a storage medium according to the invention will be described.

### First Embodiment

In a first embodiment, a configuration example when the channels of two local area networks (LANs or local networks) are connected through a wide area network (WAN or global network) to establish a virtual private network (VPN) is illustrated. A wired LAN or a wireless LAN or the like is used as the LAN. The Internet or the like is used as the WAN.

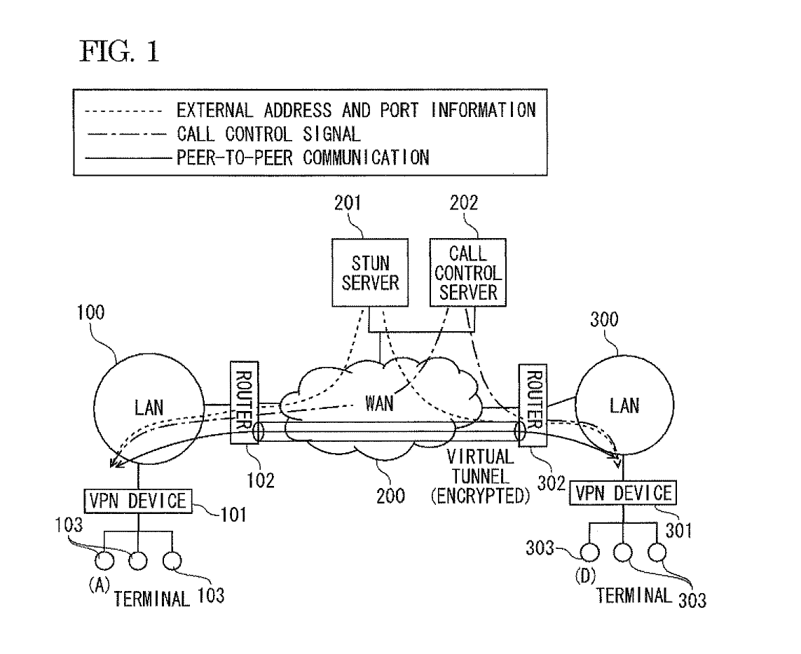

FIG. 1 is a diagram showing a configuration example of a VPN system according to the first embodiment of the invention. The VPN system of the first embodiment connects the communication channel of a LAN 100 deployed at one location and a LAN 300 deployed at the other location through a WAN 200 such as the Internet. Moreover, the VPN system enables communication (hereinafter referred to as “VPN communication”) in which confidentiality is ensured by a VPN between terminals 103 that are connected under the LAN 100 and terminals 303 that are connected under the LAN 300. As a specific use (application program or the like) of the VPN communication, IP telephony (voice call), net-meeting (video and voice communication), network camera (video transmission), and the like can be considered.

A router 102 is arranged at the boundary between the LAN 100 and the WAN 200, and a router 302 is arranged at the boundary between the WAN 200 and the LAN 300. Moreover, in the first embodiment, in order to enable establishment of a VPN, a VPN device 101 is connected to the LAN 100, and a VPN device 301 is connected to the LAN 300. Moreover, the terminals 103 are connected under the VPN device 101, and the terminals 303 are connected under the VPN device 301. In this example, although the

VPN devices 101 and 301 are illustrated as an independent device that is configured by a relay device or the like, other communication devices, terminals, or the like in the LAN may be configured as a device having the VPN function.

Moreover, on the WAN 200, a STUN server 201 and a call control server 202 are connected in order to enable VPN-based connection (hereinafter referred to as “VPN connection”) between the VPN device 101 and the VPN device 301. The STUN server 201 is a server used to implement a STUN (Simple Traversal of User Datagram Protocol (UDP) through Network Address Translators (NATs)) protocol. The call control server 202 is a server used for making and receiving calls between peers such as VPN devices or terminals.

In FIG. 1, the broken line shows the flow of external address and port information including information on external address and port. Moreover, the one-dot chain line shows the flow of a call control signal regarding the control of making and receiving calls. Moreover, the solid line shows the flow of peer-to-peer communication regarding the communication data transmitted between the peers. In addition, a communication channel connected through a VPN in order to establish peer-to-peer communication is depicted as a virtual tunnel in the figure.

When the respective devices perform communication through the WAN 200, global address information which can be specified by a WAN is used on the WAN 200 as address information for specifying the transmission source and transmission destination of packets to be transmitted. In general, since an IP network is used, a global IP address and a port number is used. However, in communications within the respective LANs 100 and 300, local address information which can be specified only within a LAN is used as the address information for specifying the transmission source and transmission destination. In general, since an IP network is used, a local IP address and a port number are used. Thus, in order to enable communication between the respective LANs 100 and 300 and the WAN 200, a NAT (Network Address Translation) function of performing interconversion between local address information and global address information is implemented in the respective routers 102 and 302.

However, the respective terminals under the LANs 100 and 300 do not possess global address information which can be accessed from the outside. Moreover, unless a special configuration is set, the terminals 103 under the LAN 100 are unable to communicate directly with the terminals 303 under the LAN 300. Moreover, due to the NAT function of the respective routers 102 and 302, in a normal state, the WAN 200 is unable to access the respective terminals in the respective LANs 100 and 300.

In such a situation, in the present embodiment, by providing the VPN devices 101 and 301 in the LANs at the respective locations, the LANs are connected through a VPN like a peer-to-peer communication channel indicated by the solid line in FIG. 1, so that the terminals 103 and the terminals 303 can directly communicate through a virtual closed communication channel. The configuration, function, and operation of the VPN device of the present embodiment will be described in the following order.

The STUN server 201 is an address information server that performs services regarding execution of a STUN protocol and provides information necessary for performing so-called communication over NAT. STUN is a standardized client-server Internet protocol used as one NAT traversal method in applications that perform bidirectional real-time IP communication of voice, video, text, or the like. In response to a request from an access source, the STUN server 201 transmits back external address and port information including information on external address and port as seen from an external network as global address information of the access source, which can be accessed from the outside. As the external address and port information, in an IP network, a global IP address and a port number are used.

The respective VPN devices 101 and 301 execute predetermined test procedure communication with the STUN server 201 and receive a response packet including the global IP address and port number of the respective terminals 103 and 303 from the STUN server 201. In this way, the respective VPN devices 101 and 301 can acquire the global IP address and port number of the respective terminals 103 and 303. Moreover, even when a plurality of routers is present between the LAN where a subject device is positioned and the WAN, and these routers or the like do not have an UPnP (Universal Plug and Play) function, it is possible to reliably acquire the global IP address and the port number.

As a method of allowing the VPN devices 101 and 301 to acquire the global IP address and port number, a method disclosed in IETF RFC 3489 (STUN—Simple Traversal of User Datagram Protocol (UDP) Through Network Address Translators (NATs)) may be used. However, the method based on STUN enables only the acquisition of a global IP address and a port number, whereas a technique of establishing a VPN in a simple and flexible manner without needing to perform an operation of configuring various parameters prior to communication is the feature of the invention.

The call control server 202 is a relay server that calls a specific counterpart to perform services regarding the control of calls between communication devices in order to establish a communication channel. The call control server 202 possesses identification information of respective users or terminals being registered and can call a specific counterpart based on a telephone number of a connection counterpart in the case of a communication system having an IP telephony function, for example. Moreover, the call control server 202 has a function of relaying signals or data and can transmit packets transmitted from a transmitter-side device to a receiver-side device and transmit packets transmitted from the receiver-side device to the transmitter-side device.

In addition, in this example, although the STUN server 201 and the call control server 202 are configured as separate servers, the functions of these two servers of an address information server and a relay server may be mounted on one server, and the same functions may be mounted on any other server on a WAN.

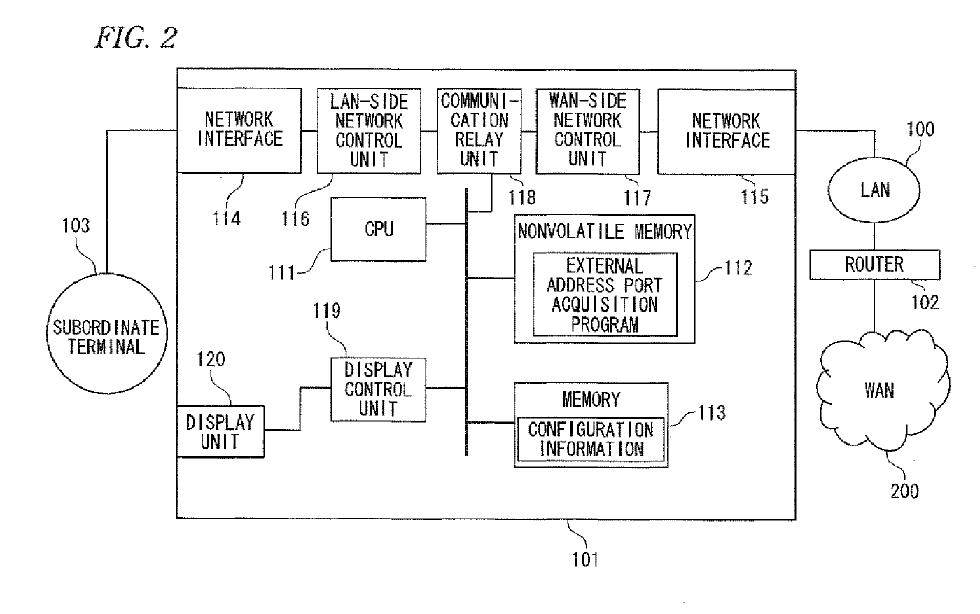

Next, the configuration and function of the VPN device according to the first embodiment will be described. Since the VPN devices 101 and 301 have the same configuration and function, the configuration and function of the VPN device 101 will be described. FIG. 2 is a block diagram showing a configuration example of a hardware configuration of the VPN device of the first embodiment.

The VPN device 101 is configured to include a microcomputer (CPU) 111, a nonvolatile memory 112 such as a flash RAM, a memory 113 such as a SD RAM, a network interface 114, a network interface 115, a LAN-side network control unit 116, a WAN-side network control unit 117, a communication relay unit 118, a display control unit 119, and display unit 120.

The microcomputer 111 executes a predetermined program to thereby control the overall operation of the VPN device 101. The nonvolatile memory 112 stores a program executed by the microcomputer 111. The program includes an external address and port acquisition program for allowing the VPN device 101 to acquire the external address and port information.

The program executed by the microcomputer 111 may be acquired online from an external server through an arbitrary communication channel, and may be acquired by reading from a recording medium such as, for example, a memory card or a CD-ROM. In other words, a VPN device and a VPN networking method can be realized by allowing a general-purpose computer (the microcomputer 111) to read a program for realizing the function of the VPN device from a recording medium.

When the microcomputer 111 executes a program, a part of a program on the nonvolatile memory 112 may be expanded onto the memory 113, and the program on the memory 113 may be executed.

The memory 113 is one for managing data being operated by the VPN device 101 and temporarily storing various setting information or the like. The setting information includes destination address information necessary for communication such as external address and port information included in the response to an external address and port acquisition request from a terminal.

The network interface 114 is an interface for connecting the VPN device 101 and the subordinate terminals 103 managed by the subject device in a communicable state. The network interface 115 is an interface for connecting the VPN device 101 and the LAN 100 in a communicable state. The LAN-side network control unit 116 is one that performs the communication control regarding the LAN-side network interface 114. The WAN-side network control unit 117 is one that performs the communication control regarding the WAN-side network interface 115.

The communication relay unit 118 relays packet data transmitted from a subordinate terminal 103 connected to the LAN side to an external VPN connection destination (a terminal 303 under the control of the VPN device 301), and conversely, relays packet data that is transmitted from the external VPN connection destination (the terminal 303 under the control of the VPN device 301) and arrived at the subordinate terminal 103.

The display unit 120 is configured by a display that displays the operation state or the like of the VPN device 101 and informs a user or an administrator of various states. The display unit 120 is configured by a plurality of light-emitting diodes (LEDs), a liquid crystal display (LCD), or the like. The display control unit 119 performs the display control of the display unit 120 and controls the content or the like displayed on the display unit 120 in accordance with a display signal from the microcomputer 111.

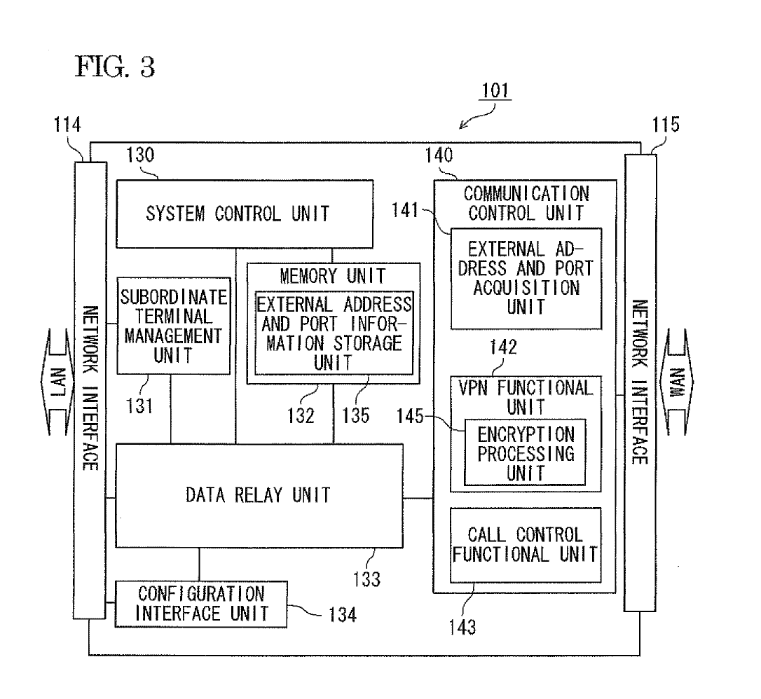

FIG. 3 is a block diagram showing a functional configuration example of the VPN device of the first embodiment.

The VPN device 101 is configured to include, as its functional configuration, a system control unit 130, a subordinate terminal management unit 131, a memory unit 132, a data relay unit 133, a configuration interface unit 134, and a communication control unit 140. The memory unit 132 includes an external address and port information storage unit 135. The communication control unit 140 includes an external address and port acquisition unit 141, a VPN functional unit 142, and a call control functional unit 143. The VPN functional unit 142 includes an encryption processing unit 145. These respective functions are realized by the hardware operations of the respective blocks shown in FIG. 2 or by the microcomputer 111 executing a predetermined program.

The LAN-side network interface 114 of the VPN device 101 is connected to the subordinate terminals 103, and the WAN-side network interface 115 is connected to the WAN 200 through the LAN 100 and the router 102.

The system control unit 130 controls the overall operation of the VPN device 101. The subordinate terminal management unit 131 manages the terminals 103 under the VPN device 101. The memory unit 132 stores external address and port information including information on external address (the global IP address on the WAN 200) and port (port number of an IP network) in the external address and port information storage unit 135. As the external address and port information, information on a global IP address and a port number allocated to a subordinate terminal 103 which is a connection source, information on a global IP address and a port number allocated to a connection destination terminal 303, and the like are stored.

The data relay unit 133 relays packets transmitted from a connection source terminal 103 to a connection destination terminal 303, and conversely, packets transmitted from the connection destination terminal 303 to the connection source terminal 103. The configuration interface unit 134 is a user interface for allowing a user or an administrator to perform various operations such as setting operations on the VPN device 101. As a specific example of the user interface, a Web page or the like that displays information using a browser operating on a terminal is used.

The external address and port acquisition unit 141 of the communication control unit 140 acquires the external address and port information allocated to the subordinate terminals 103 of the VPN device 101 from the STUN server 201. Moreover, the external address and port acquisition unit 141 receives packets including the external address and port information of the connection destination terminal 303 through the call control server 202 to acquire the external address and port information allocated to the connection destination terminal 303. Details of the external address and port information acquisition operation will be described later. The information acquired by the external address and port acquisition unit 141 is stored in the external address and port information storage unit 135 of the memory unit 132.

The VPN functional unit 142 of the communication control unit 140 performs an encryption process necessary for VPN communication on the encryption processing unit 145. That is, the encryption processing unit 145 encapsulates and encrypts packets to be transmitted and uncapsulates and decrypts received packets to extract original packets. The encryption operation will be described later. The VPN communication may not be performed by peer-to-peer communication as shown in FIG. 1, but a server installed on the WAN 200 may relay packets, and VPN communication may be performed by a client-server system. In this case, encryption may be performed on the server side.

The call control functional unit 143 performs a process of transmitting a connection request for connecting to a target connection destination to the call control server 202 and a process of receiving a connection response from the connection destination through the call control server 202.

That is, the communication control unit 140 realizes the respective functions of an external address and port acquisition unit that acquires external address and port information of a subject device, a subject device address information transmission unit that transmits the external address and port information of the subject device, a counterpart device address information reception unit that receives external address and port information of a counterpart device, an encryption processing unit that encrypts communication data, and a data transmission unit that transmits the communication data. Moreover, the communication control unit 140 also includes the function of a communication channel maintaining unit that maintains a communication channel of VPN communication.

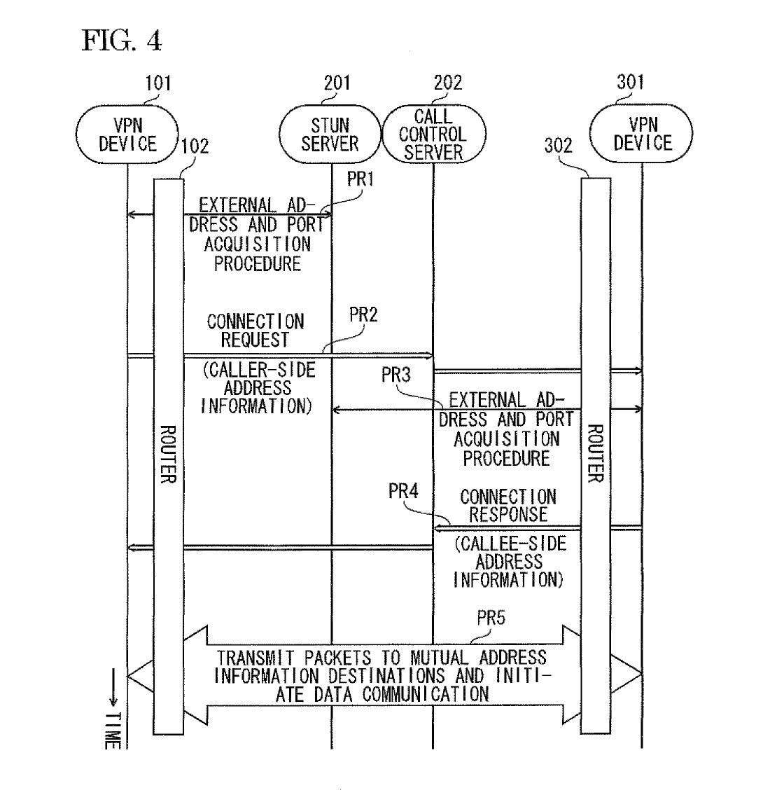

Next, the operation of the VPN device 101 of the present embodiment when establishing a VPN will be described. FIG. 4 is a sequence diagram showing a processing procedure when the VPN system of the first embodiment establishes a VPN. FIG. 4 shows a process in a network including a VPN device when a terminal 103 under the control of the VPN device 101 connects to a terminal 303 under the control of another VPN device 301 through the WAN 200.

First, prior to the process shown in FIG. 4, a terminal 103 logs into the call control server 202 and passes through user authentication. When the terminal 103 succeeds in the user authentication, the identification information (MAC address, user ID, telephone number, or the like) of the terminal 103, position information (global IP address) on a network, and the like are registered and set to the call control server 202. After that, the terminal 103 and the call control server 202 can communicate with, each other.

In this state, upon receiving a VPN connection request from the subordinate terminal 103, the VPN device 101 performs an external address and port acquisition procedure with the STUN server 201 by the function of the external address and port acquisition unit 141 upon activation of an application that performs VPN communication (PR1). In this case, the VPN device 101 transmits a binding request (connection request, see RFC 3489; the same herein below) packet to the STUN server 201 as an external address and port acquisition request in order to acquire the external address and port information (the global IP address and port number as seen from the WAN 200 side) allocated to the terminal 103. On the other hand, in response to the external address and port acquisition request, the STUN server 201 transmits back a binding response (connection response, see RFC 3489: the same herein below) packet to the VPN device 101 as an external address and port information response. Moreover, the VPN device 101 stores the external address and port information obtained by the external address and port information response.

Subsequently, the VPN device 101 transmits a connection request to the call control server 202 to establish a communication channel for P2P (Peer-to-Peer) communication to the VPN device 301 having the connection destination terminal 303 under the control thereof (PR2). In this case, the VPN device 101 transmits a connection request including the external address and port information (the global IP address and port number) of the terminal 103 acquired in the external address and port acquisition procedure is PR1 to the call control server 202 as caller-side address information. The call control server 202 relays the connection request to the VPN device 301 which is the connection destination of the VPN connection. With this connection request, the call control server 202 informs the connection destination of a request that the VPN device 101 wants to make VPN connection to the VPN device 301 to establish a P2P channel.

Upon receiving the connection request from the call control server 202, the connection destination VPN device 301 performs an external address and port acquisition procedure with the STUN server 201 (PR3). In this case, similarly to the VPN device 101, the VPN device 301 transmits a binding response packet to the STUN server 201 as an external address and port acquisition request in order to acquire the external address and port information (the global IP address and port number as seen from the WAN 200 side) allocated to the terminal 303. On the other hand, in response to the STUN server 201, the STUN server transmits back a binding response packet including the external address and port information to the VPN device 301 as an external address and port information response. Moreover, the VPN device 301 stores the external address and port information obtained by the external address and port information response.

Subsequently, the VPN device 301 transmits a connection response to the connection request to the call control server 202 (PR4), In this case, the VPN device 301 transmits a connection response including the external address and port information (the global IP address and port number) of the terminal 303 acquired in the external address and port acquisition procedure PR3 to the call control server 202 as callee-side address information. The call control server 202 relays and transmits the connection response to the VPN device 101 which is a connection requester of the VPN connection.

With this connection response, the call control server 202 informs the connection requester of a response to the connection request from the VPN device 301 to the VPN device 101.

At this stage, the connection source VPN device 101 and the connection destination VPN device 301 have acquired the external address and port information of the terminals 103 and 303. Thus, the VPN devices 101 and 301 set the external address and port information (the global IP address and port number) of the subordinate terminals 303 and 103 of the mutual counterpart VPN devices as a transmission destination to transmit packets through the WAN 200, check communicability (VPN connectability), and initiate encrypted data communication (VPN communication) (PR5).

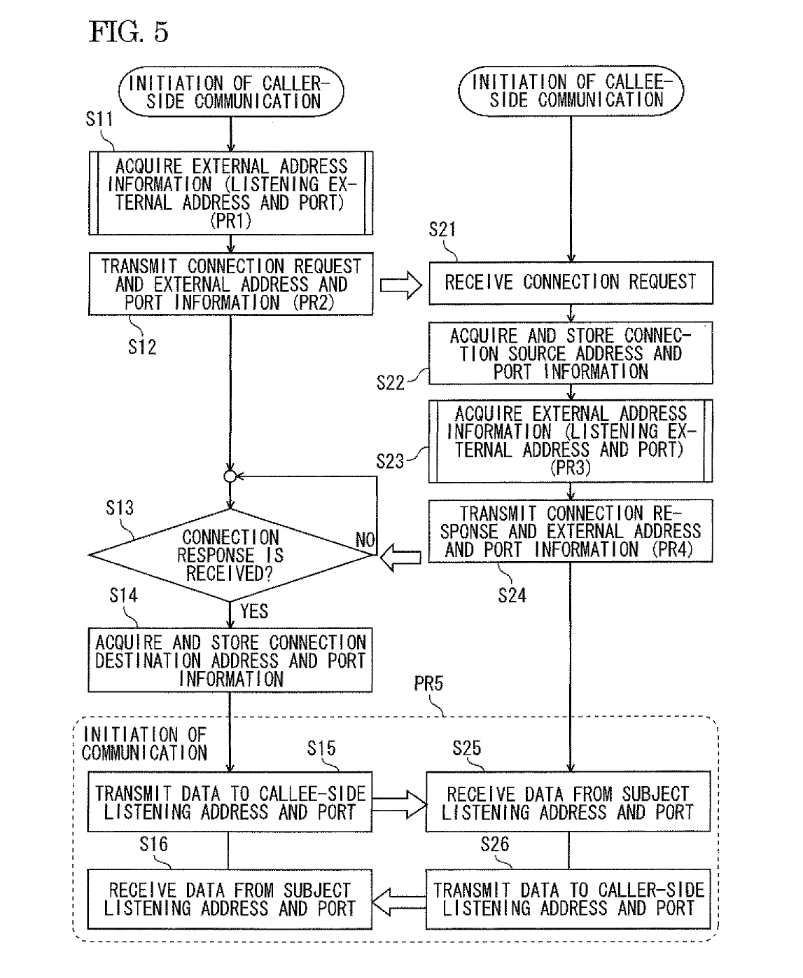

FIG. 5 is a flowchart showing the processing details when the VPN device of the first embodiment establishes a VPN. FIG. 5 shows the specific processing details of the processes when establishing a VPN in FIG. 4. In FIG. 5, steps S11 to S16 show the content of processes performed by the connection source (caller-side) VPN device 101, and steps S21 to S26 show the content of processes performed by the connection destination (callee-side) VPN device 301.

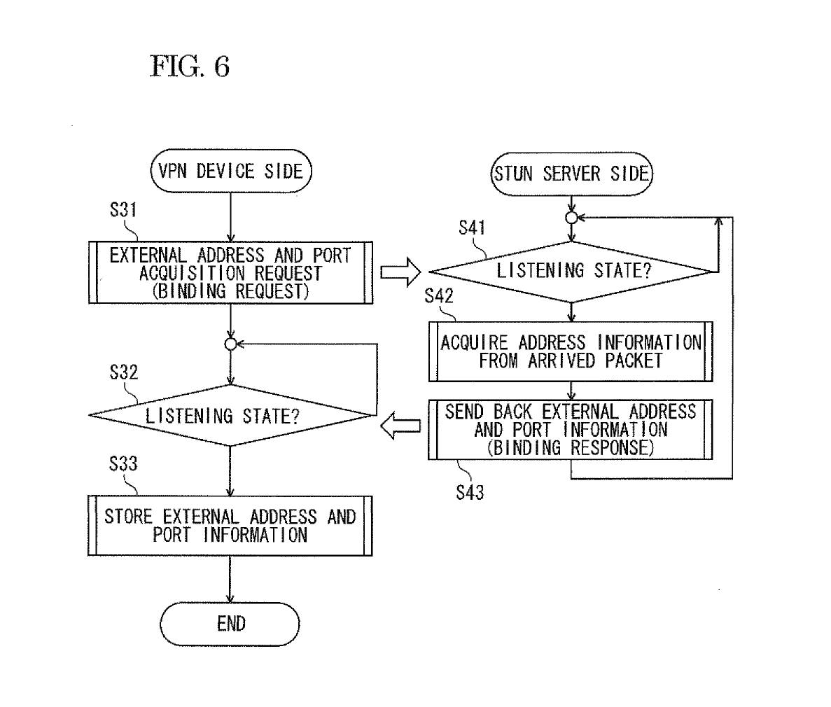

In order to make VPN connection when establishing a VPN, first, the caller-side VPN device 101 performs a process of acquiring the external address and port information including the global IP address and port number of the terminal 103 as information on listening external address and port (PR1, step S11). Details of the external address information acquisition process will be described in detail with reference to FIG. 6.

Subsequently, the VPN device 101 transmits a connection request to the callee-side VPN device 301 (PR2, step S12). The connection request includes identification information or the like for specifying the connection destination terminal 303. Moreover, the connection request including the external address and port information of the terminal 103 acquired in step S11 is transmitted. The connection request is transmitted to the VPN device 301 through the call control server 202.

The callee-side VPN device 301 receives the connection request from the VPN device 101 (step S21). Upon receiving the connection request, the VPN device 301 extracts the external address and port information of the connection source terminal 103 included in the connection request and stores the information in a memory (step S22). Moreover, the VPN device 301 performs a process of acquiring the external address and port information including the global IP address and port number of the terminal 303 as information on listening external address and port similarly to step S11 (step S23).

Subsequently, the VPN device 301 transmits a connection response to the connection request received from the caller-side VPN device 101 (step S24). The connection response including the external address and port information of the terminal 303 acquired in step S23 is transmitted. The connection response is transmitted to the VPN device 101 through the call control server 202.

The caller-side VPN device 101 performs listening for a connection response by determining whether the connection response has been received (step S13). Upon receiving the connection response, the VPN device 101 extracts the external address and port information of the connection destination terminal 303 included in the connection response and stores the information in a memory (step S14).

Through the above processes, at the time of executing a data communication initiation process PR5, the caller-side VPN device 101 and the callee-side VPN device 301 have acquired the external address and port information of the terminals 103 and 303 and the external address and port information of the caller-side VPN device 101.

After data communication is initiated, the caller-side VPN device 101 transmits data on the WAN 200 to the VPN device 301 using the global IP address and port number of the terminal 303 that the callee-side VPN device 301 listens on as a destination (step S15). On the other hand, the VPN device 301 listens for data using the global IP address and port number of the terminal 303 and receives data transmitted from the caller-side VPN device 101 (step S25). Moreover, the callee-side VPN device 301 transmits data on the WAN 200 to the VPN device 101 using the global IP address and port number of the terminal 103 that the caller-side VPN device 101 listens on as a destination (step S26). On the other hand, the VPN device 101 listens for data using the global IP address and port number of the terminal 103 and receives data transmitted from the callee-side VPN device 301 (step S16). The feature of the invention associated with from listening to reception will be described in detail as “hole punching.”

When the VPN devices 101 and 301 have successfully transmitted and received data, it is recognized that VPN connection is established between the VPN device 101 and the VPN device 301. Thereafter, the VPN devices 101 and 301 can perform direct P2P communicate without going through a server, and encrypted VPN communication is performed between the terminal 103 under the VPN device 101 and the terminal 303 under the VPN device 301.

When terminating the VPN communication, the VPN devices 101 and 301 close ports used in the VPN communication. In this way, since external access to the corresponding ports is disabled, it is possible to block security holes. Here, the respective ports correspond to applications, and communication is performed by designating a port number allocated to each application when making VPN connection.

For example, when an application is terminated on the terminal 103 side, since no packets are transmitted from the terminal 103 to the VPN device 101 for a certain period, the VPN device 101 determines that the communication with the terminal 103 is terminated, and stops communicating with the router 102. As a result, the VPN communication is terminated, and the ports of the router 102 are closed. In this way, VPN communication is performed with a communication counterpart terminal as necessary, and when communication is terminated, it is possible to terminate the VPN communication and block security holes.

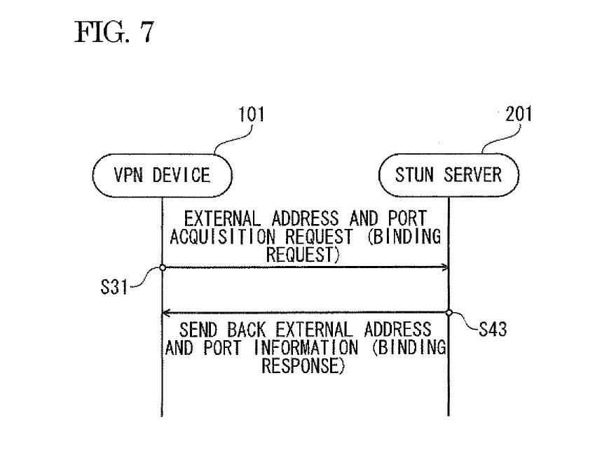

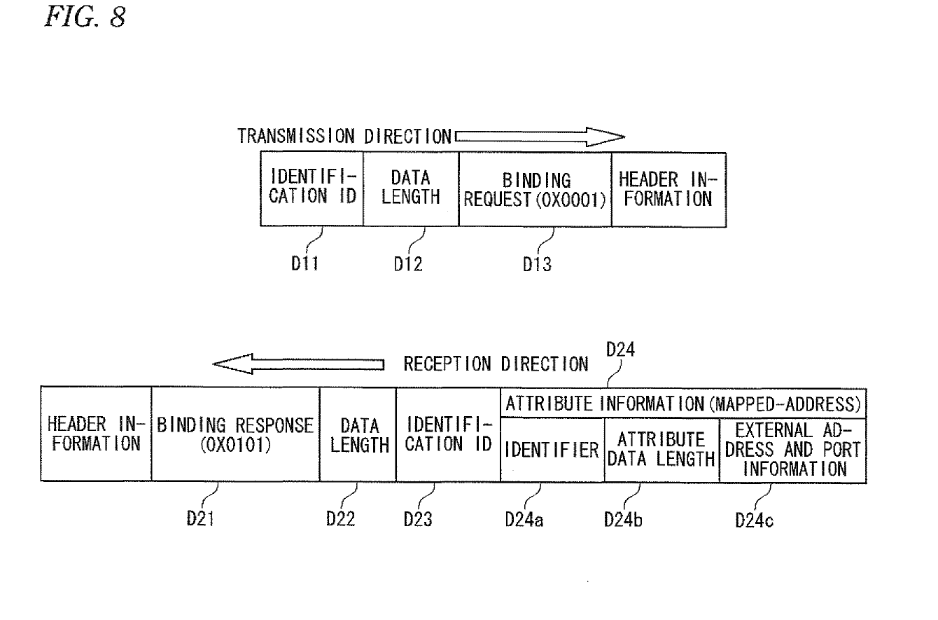

Next, the external address information acquisition process shown in step S11 will be described. FIG. 6 is a flowchart showing the processing details of the external address information acquisition process, and FIG. 7 is a sequence diagram showing a processing procedure of the external address and port acquisition request. Moreover, FIG. 8 is a diagram showing the packet structures of the external address and port acquisition request and the external address and port information response. In FIG. 6, the operations of the VPN device and the STUN server during the external address information acquisition process are shown.

The VPN device 101 transmits a binding request packet to the STUN server 201 as the external address and port acquisition request (step S31). As shown on the upper side of FIG. 8, the binding request packet includes a region D11 in which the identification ID (transaction ID) of this request is included, a region D12 in which information (data Length) on data length is included, and a region D13 in which a code (0x0001) is included indicating that this packet is a “binding request.” Moreover, although not shown in FIG. 8, information on the global IP address and port number indicating a transmission source or a transmission destination is included in the header of an actual packet.

The STUN server 201 listens for the external address and port acquisition request in a listening state (step S41). Here, when receiving the binding request packet, the STUN server 201 acquires the external address and port information (global IP address and port number) of the terminal 103 as seen from the WAN side (step S42).

Moreover, the STUN server 201 transmits a binding response packet to the VPN device 101 as an external address and port information response to the binding request packet of the external address and port acquisition request (step S43). As shown on the lower side of FIG. 8, the binding response packet includes a region D21 in which a code (0x0101) is included indicating that this packet is a “binding response,” a region D22 in which information (data Length) on data length is included, a region D23 in which identification ID of this response is included, and a region D24 in which attribute information (MAPPED-ADDRESS) is included. The attribute information region D24 includes an identifier region D24a, an attribute data length region D24b, and an external address and port information region D24c. The STUN server 201 transmits a response by loading information on the external address (global IP address) and port (port number) allocated to the terminal 103 acquired in step S42 into the external address and port information region D24c.

After transmitting the external address and port acquisition request, the VPN device 101 listens for an external address and port information response in a listening state (step S32). Here, upon receiving the binding response packet, the VPN device 101 extracts the external address and port information (global IP address and port number) included in the binding response packet and stores the information in a memory (step S33).

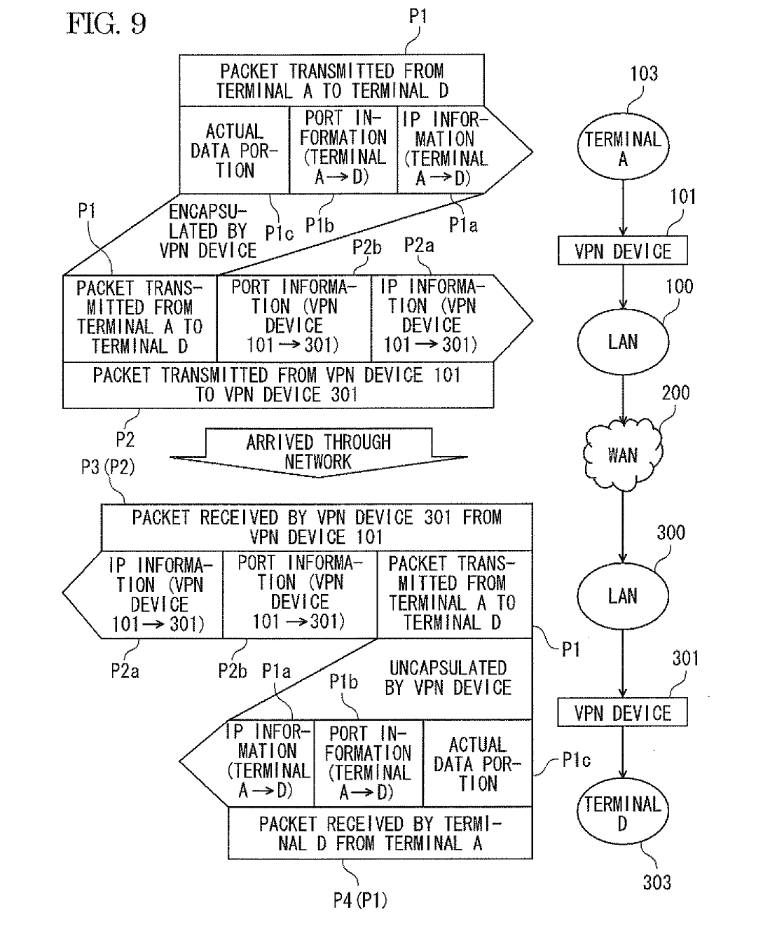

Here, the packet transmitted during the VPN communication after the VPN connection is established will be described. FIG. 9 is a diagram showing the packet structures during the VPN communication. FIG. 9 shows the encapsulation and uncapsulation of packets when the packets are transmitted from the caller-side terminal 103 to the callee-side terminal 303 through the VPN device 101, the WAN 200, and the VPN device 301.

In the VPN connection, the VPN functional unit 142 in the VPN devices 101 and 301 forms a VPN tunnel session between the VPN device 101 and the VPN device 301. In this way, P2P connection is established, whereby packets can be securely transmitted while ensuring confidentiality of the communication between the transmission source terminal 103 and the transmission destination terminal 303. In the channel of the tunnel session, packets encapsulated and encrypted by the encryption processing unit 145 of the VPN functional unit 142 are transmitted.

On top of FIG. 9, a packet P1 which is an IP packet which a VPN communication application on the transmission source terminal 103 (terminal A) transmits to a communication counterpart terminal 303 (terminal D) is shown. The packet P1 includes IP address information P1a of the transmission source terminal A and the transmission destination terminal D, port information P1b of ports used for transmission from the terminal A to the terminal D, and actual data portion P1c which is actually transmitted.

When receiving and relaying the packet P1 transmitted from the subordinate terminal 103 (terminal A), the VPN device 101 performs encryption and encapsulation in the VPN functional unit 142 to generate and transmit a packet P2. In the encapsulated packet P2, in addition to the packet P1 transmitted from the terminal A to the communication counterpart terminal D, IP address information P2a of the transmission source VPN device 101 and the transmission destination VPN device 301 and port information P2b used for transmission from the VPN device 101 to the VPN device 301 are included. In this case, the VPN device 101 encapsulates the packet P2 using a UDP (User Datagram Protocol) and transmits the encapsulated packet to the VPN device 301.

The encapsulated packet P2 is transmitted from the VPN device 101 and arrives at the VPN device 301 through the LAN 100, the router 102, the WAN 200, the router 302, and the LAN 300.

A packet P3 received by the VPN device 301 is the same as the packet P2 transmitted from the VPN device 101. That is, in the encapsulated packet P3, the IP address information P2a of the VPN devices 101 and 301, the port information P2b used for transmission from the VPN device 101 to the VPN device 301, and the packet P1 transmitted from the terminal A to the communication counterpart terminal D are included. When receiving and relaying the packet P3, the VPN device 301 uncapsulates and extracts the packet P1 which is to be received by the subordinate terminal 303 from the encapsulated packet P3 and transmits the packet P1 to the terminal 303. The terminal 303 (terminal D) can receive a packet P4 of the same content as the packet P1 transmitted from the transmission source terminal 103 (terminal A).

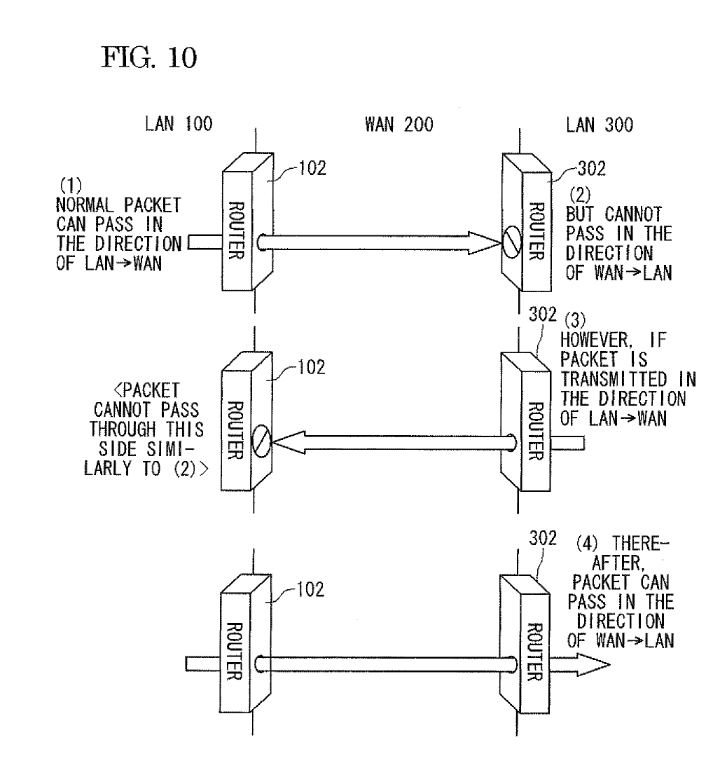

Next, UDP hole punching between the LANs 100 and 300 will be described. FIG. 10 is a diagram showing a state transition of a UDP hole punching operation.

In a network in which a plurality of LANs is connected through a

WAN, in general, like the configuration of the VPN system as shown in FIG. 1, the routers 102 and 302 are installed at the boundary between the LAN 100 and the WAN 200 and the boundary between the WAN 200 and the LAN 300, respectively. Thus, in a normal state, packets cannot be directly transmitted between the terminal 103 in the LAN 100 and the terminal 303 in the LAN 300. This is because in the case of UDP, the respective routers 102 and 302 block packets incoming from the external WAN 200 into the LANs 100 and 300.

Therefore, on the top of FIG. 10, packets outgoing from the LAN 100 to the WAN 200 are allowed to pass as indicated by (1), whereas packets incoming from the WAN 200 into the LAN 300 are not allowed to pass as indicated by (2). That is, as shown on the top of FIG. 10, when a packet is transmitted from the LAN 100 side to the LAN 300 through the router 102, the WAN 200, and the router 302, the packets is blocked by the router 302 and prevented from entering into the LAN 300.

However, as indicated by (3) on the middle of FIG. 10, immediately after an operation of transmitting a packet from the LAN 300 to the WAN 200 is performed, a state where a hole is temporarily open in the corresponding transmission source-transmission destination address and port in the router 302 is created. In this case, as indicated by (4) on the bottom of FIG. 10, a packet passes from the external WAN 200 side into the LAN 300. That is, packets from the transmission destination LAN 100 side can pass to the LAN 300 side of the router 302 through the router 102 and the WAN 200 using the port of the router 302 in which a hole is temporarily open as the result of transmission of a packet from the LAN 300 to the LAN 100. The same statement is applied to the reverse direction.

In order to receive packets from a communication counterpart using the function of a router, the VPN devices 101 and 301 may perform an operation of transmitting packets from their own LAN side to the communication counterpart in advance as indicated by (3). However, the use port in which a hole is open to the outside as the result of packet transmission is automatically closed when a predetermined period is elapsed. Thus, in order to maintain the port through which communication from the WAN side to the LAN is possible, the operation indicated by (3) needs to be performed periodically at an interval of about 10 seconds, for example, or intermittently. Such an operation of transmitting packets from the LAN to the WAN in advance or such an operation of transmitting packets intermittently to maintain the port is referred to as hole punching.

The port information used for the hole punching can be received from the STUN server 201 by the VPN devices 101 and 301 performing the external address and port information acquisition process described above. When the external address and port information of a subject device is transmitted and stored in the communication counterpart VPN devices, packets can be directly transmitted to the communication counterparts to perform hole punching, and the packets from the communication counterparts can be received.

Even when there is no data to be transmitted after VPN connection is established, the VPN devices 101 and 301 repeatedly perform the hole punching operation in order to maintain a communicable state until the VPN devices 101 and 301 determine that the applications on the terminals 103 and 303 have been terminated. For example, transmission and reception of a certain UDP packet with a communication counterpart is repeatedly performed at a predetermined interval at a cycle of about 10 seconds to thereby maintain the port of the VPN communication channel.

When terminating the VPN communication, the respective VPN devices 101 and 301 determine that the applications on the terminals 103 and 303 have been terminated (or simply, communication has been terminated) and stop the transmission and reception of the UDP packet to thereby end the hole punching operation. In this way, the use port is closed, and unauthorized intrusion from the WAN side to the LAN side is prevented. Thus, ports can be blocked at times other than the VPN communication and open during the VPN communication, whereby highly secure communication can be performed.

In addition, in the case of communication using a plurality of sessions/ports at the same time, for example, when applications transmitting signaling and voice packets in parallel perform communication, a configuration in which the following processes are performed may be used.

That is, only packets which require a small transmission delay like voice packets are transmitted through a P2P communication channel according to the present embodiment, and signaling packets which rarely cause problems even if there is a great delay are relayed by a server on the WAN and transmitted.

The first embodiment described above can be applied to a software VPN that establishes a VPN by software. The software VPN can freely incorporate a VPN function into a device such as a computer or an information appliance, and connection in a minuter unit without being limited to connection between network segments. That is, the software VPN enables connection in an application unit rather than a location unit by cooperating with various communication applications of devices connected to a network. In the software VPN, a P2P communication channel is established between a subject device and a counterpart device using a tunneling technique which uses IPsec or SSL to thereby perform encrypted communication.

For example, when a LAN and a WAN are connected through a NAT router, there is a limitation in the allowability of opening a UDP port which is dynamically used, the range of ports being used, and the like. Thus, in the VPN device of the related art, it was indispensable to configure a VPN device in advance so as to meet these conditions when installing the VPN device. In contrast, in the first embodiment, the STUN server acquires the external address and port information of a subject device and exchanges the external address and port information with a counterpart device, whereby the two devices can perform encrypted communication using the external address and port information of the counterpart device. Thus, it is not necessary to perform an operation of setting various parameters in advance, and a VPN can be established in a simple and flexible manner.

As above, according to the first embodiment, the VPN device at each location does not need to assign a predetermined identification number or the like as in the related art and perform a setting operation in advance before installing the device so that an appropriate port can be used, and an encryption code can be encrypted or decrypted. Moreover, it is not necessary to ensure that a VPN session is always effectively initiated between the VPN devices at bases where VPN communication is performed. Thus, for example, even when a user wants to make VPN connection temporarily from an office of a certain company to an office of another company, the user can easily perform VPN communication at a necessary time for a necessary period without performing a setting operation in advance.

Moreover, in the first embodiment, a subject device can perform. VPN connection with a counterpart device as necessary, initiate encrypted communication, and close a use port to block a communication channel when terminating communication. In this way, it is possible to prevent unauthorized access to a port open for communication, and no security hole will be created. Thus, temporary use of a VPN is easily realized, and security thereof can be increased. In VPN communication, tunneling and encapsulation are performed using IPsec or SSL, and packets are encapsulated by a UDP and are transmitted to the counterpart device, whereby it is possible to prevent leakage, eavesdropping, falsification of information on the WAN and to perform communication ensuring confidentiality. Moreover, since P2P communication through VPN connection is possible between LANs, a client/server system configuration with a relay server is not essential, and it is possible to obviate an increase in a processing load of the relay server, a delay during the relaying, and the like.

The invention is intended to be susceptible to various alterations and applications conceived by those skilled in the art on the basis of descriptions of the specification and well-known technologies without departing from the spirit and scope of the invention, and such alterations and applications shall fall within the range where protection of the invention is sought. For example, the invention is not to be construed in a limiting sense such that the presence of the STUN server 201 and the call control server 202 on the WAN 200 is essential. A means and information source capable of acquiring the external address and port information of the subject device can be substituted with the STUN server 201, and it is possible to correspond to techniques such as, for example, hybrid P2P, pure P2P, or DHT. Moreover, a technique of establishing a communication channel with a communication counterpart following the order of nodes can be substituted with the call control server 202, and it is possible to correspond to techniques such as, for example, SMTP or DNS.

Furthermore, the packet communicated by the VPN devices 101 and 301 is not to be construed to be limited to the UDP packet. Alternatively, the VPN devices 101 and 301 do not necessarily have the terminals 103 and 303 under the control thereof, and a configuration in which the terminals 103 and 303 read the program of the VPN device of the invention so that the terminals themselves function as the VPN device shall fall within the range where protection of the invention is sought.

### Second Embodiment

In the second embodiment, a diagram showing a configuration example of a VPN system, a block diagram showing a configuration example of a hardware configuration of a VPN device, and a block diagram showing a functional configuration example of the VPN device are the same as FIGS. 1 to 3 used in the first embodiment.

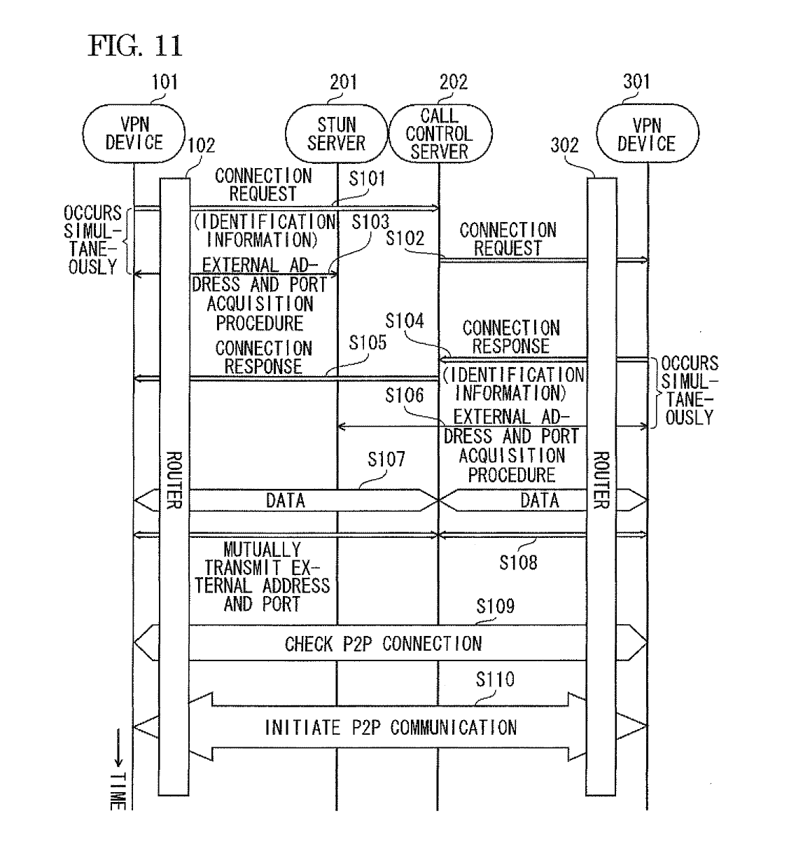

Next, the operation of the VPN device 101 of the second embodiment when establishing a VPN will be described. FIG. 11 is a sequence diagram showing a processing procedure when the VPN system of the second embodiment establishes a VPN. FIG. 11 shows a process in a network including a VPN device when a terminal 103 under the control of the VPN device 101 connects to a terminal 303 under the control of another VPN device 301 through the WAN 200.

First, prior to the process shown in FIG. 11, the VPN device 101 logs into the call control server 202 and passes through user authentication. When the VPN device 101 succeeds in the user authentication, the identification information (MAC address, user ID, telephone number, or the like) of the VPN device 101, position information (global IP address) on a network, and the like are registered and set to the call control server 202. After that, the VPN device 101 and the call control server 202 can communicate with each other. Although the VPN device 101 is a caller side, the VPN device 301 which is the callee side also logs into the call control server 202 and passes through user authentication, and the identification information or the like of the VPN device 301 is registered and set to the call control server 202.

In this state, upon receiving a VPN connection request from the subordinate terminal 103, the VPN device 101 transmits a connection request to the call control server 202 to establish a communication channel for P2P (Peer-to-Peer) communication to the VPN device 301 having the connection destination terminal 303 under the control thereof by the function of the external address and port acquisition unit 141 upon activation of an application that performs VPN communication (step S101). In this case, the VPN device 101 transmits a connection request including the caller and callee-side identification information to the call control server 202. The call control server 202 relays and transmits the connection request to the VPN device 301 which is the connection destination of the VPN connection (step S102). With this connection request, the call control server 202 informs the connection destination of a request that the VPN device 101 wants to make VPN connection to the VPN device 301 to establish a P2P channel.

Concurrently with the connection request by the VPN device 101, the VPN device 101 performs an external address and port acquisition procedure with the STUN server 201 (step S103). In this case, the VPN device 101 transmits a binding request (connection request, see RFC 3489; the same herein below) packet to the STUN server 201 as an external address and port acquisition request in order to acquire the external address and port information (the global IP address and port number as seen from the WAN 200 side) allocated to the subject device. On the other hand, in response to the external address and port acquisition request, the STUN server 201 transmits back a binding response (connection response, see RFC 3489: the same herein below) packet to the VPN device 101 as an external address and port information response. Moreover, the VPN device 101 stores the external address and port information obtained by the external address and port information response.

Upon receiving the connection request from the call control server 202, the connection destination VPN device 301 transmits a connection response to the connection request to the call control server 202 (step S104). In this case, the VPN device 301 transmits a connection response including the caller and callee-side identification information to the call control server 202. The call control server 202 relays and transmits the connection response to the VPN device 101 which is a connection requester of the VPN connection (step S105). With this connection response, the call control server 202 informs the connection requester of a response to the connection request from the VPN device 301 to the VPN device 101.

Concurrently with the connection response by the VPN device 301, the VPN device 301 performs an external address and port acquisition procedure with the STUN server 201 (step S106). In this case, similarly to the VPN device 101, the VPN device 301 transmits a binding request packet to the STUN server 201 as an external address and port acquisition request in order to acquire the external address and port information (the global IP address and port number as seen from the WAN 200 side) allocated to the subject device. On the other hand, in response to the external address and port acquisition request, the STUN server 201 transmits back a binding response packet to the VPN device 301 as an external address and port information response. Moreover, the VPN device 301 stores the external address and port information obtained by the external address and port information response.

When the VPN device 101 receives a connection response including a connection permission from the VPN device 301, the VPN devices 101 and 301 communicate actual data (voice packets, video packets, and the like) through the call control server 202 (step S107). That is, actual data communication is initiated before the P2P communication channel is established.

Subsequently, the VPN devices 101 and 301 inform the counterpart devices of the external address and port information of the subject devices acquired from the STUN server 201 through the call control server 202 (step S108). Moreover, the VPN devices 101 and 301 determine whether they are in a state (P2P communicable state) where P2P communication can be performed between the VPN devices 101 and 301 using the mutually received counterpart external address and port information (step S109). In this example, the VPN devices 101 and 301 set the external address and port information (the global IP address and port number) of the counterpart devices as a transmission destination to transmit packets through the WAN 200, and check communicability (VPN connectability). For example, the VPN device 101 transmits a packet to the VPN device 301, and when a response indicating the receipt of the packet is received from the VPN device 301 within a predetermined period from the transmission, it is determined that they are in the P2P communicable state.

When they are in the P2P communicable state, since the P2P communication channel is established, the VPN devices 101 and 301 initiate encrypted actual data communication by P2P communication (step S110).

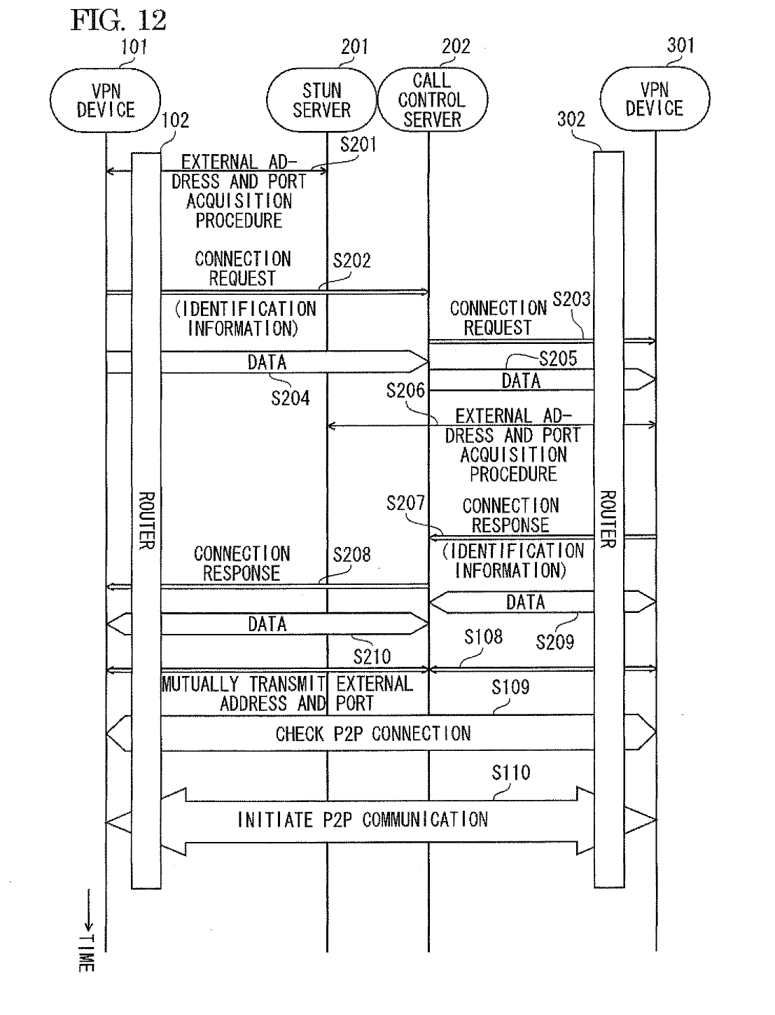

Next, FIG. 12 is a sequence diagram showing another processing procedure when the VPN system of the second embodiment establishes a VPN. FIG. 12 shows a process in a network including a VPN device when a terminal 103 under the control of the VPN device 101 connects to a terminal 303 under the control of another VPN device 301 through the WAN 200.

First, similarly to the processing procedure of FIG. 11, the VPN devices 101 and 301 log into the call control server 202 and pass through user authentication, and the identification information and the like of the terminals 103 and 303 are registered and set to the call control server 202.

In this state, upon receiving a VPN connection request from the subordinate terminal 103, the VPN device 101 performs an external address and port acquisition procedure with the STUN server 201 by the function of the external address and port acquisition unit 141 upon activation of an application that performs VPN communication (step S201). In this case, the VPN device 101 transmits a binding request packet as an external address and port acquisition request to the STUN server 201 in order to acquire the external address and port information allocated to the subject device. On the other hand, in response to the external address and port acquisition request, the STUN server 201 transmits back a binding response packet including the external address and port information as an external address and port information response to the VPN device 101. Moreover, the VPN device 101 stores the external address and port information obtained by the external address and port information response.

Subsequently, a connection request is transmitted to the call control server 202 to establish a P2P communication channel to the VPN device 301 having the connection destination terminal 303 under the control thereof (step S202). In this case, the VPN device 101 transmits a connection request including the caller and callee-side identification information to the call control server 202. The call control server 202 relays and transmits the connection request to the VPN device 301 which is the connection destination of the VPN connection (step S203). With this connection request, the call control server 202 informs the connection destination of a request that the VPN device 101 wants to make VPN connection to the VPN device 301 to establish a P2P channel.

Moreover, when transmitting a connection request to the VPN device 301, the VPN device 101 transmits actual data through the call control server 202. Moreover, the VPN device 301 receives the actual data (steps S204 and S205).

Upon receiving the connection request from the call control server 202, the connection destination VPN device 301 performs an external address and port acquisition procedure with the STUN server 201 (step S206). In this case, similarly to the VPN device 101, the VPN device 301 transmits a binding request packet as an external address and port acquisition request to the STUN server 201 in order to acquire the external address and port information allocated to the subject device. On the other hand, in response to the external address and port acquisition request, the STUN server 201 transmits back a binding response packet including the external address and port information as an external address and port information response to the VPN device 301. Moreover, the VPN device 301 stores the external address and port information obtained by the external address and port information response.

Subsequently, the VPN device 301 transmits a connection response to the connection request to the call control server 202 (step S207). In this case, the VPN device 301 transmits a connection response including the caller and callee-side identification information to the call control server 202. The call control server 202 relays and transmits the connection response to the VPN device 101 which is a connection requester of the VPN connection (step S208). With this connection response, the call control server 202 informs the connection requester of a response to the connection request from the VPN device 301 to the VPN device 101.

Moreover, when transmitting a connection response including a connection permission to the VPN device 101, the VPN device 301 communicates (transmits and receives) actual data with the VPN device 101 through the call control server 202 (steps S209 and S210). The processes after the VPN devices 101 and 301 initiate the data communication are the same as those of steps S108 to S110 of FIG. 11.

According to the processing procedures of FIGS. 11 and 12, since actual data communication is performed through the call control server 202 before the P2P communication channel is established, it is possible to obviate a delay in the data communication resulting from the time needed to check whether it is in the P2P communicable state and to accelerate data communication. In particular, in FIG. 12, since actual data can be transmitted together with the connection request, it is possible to further accelerate the data communication.

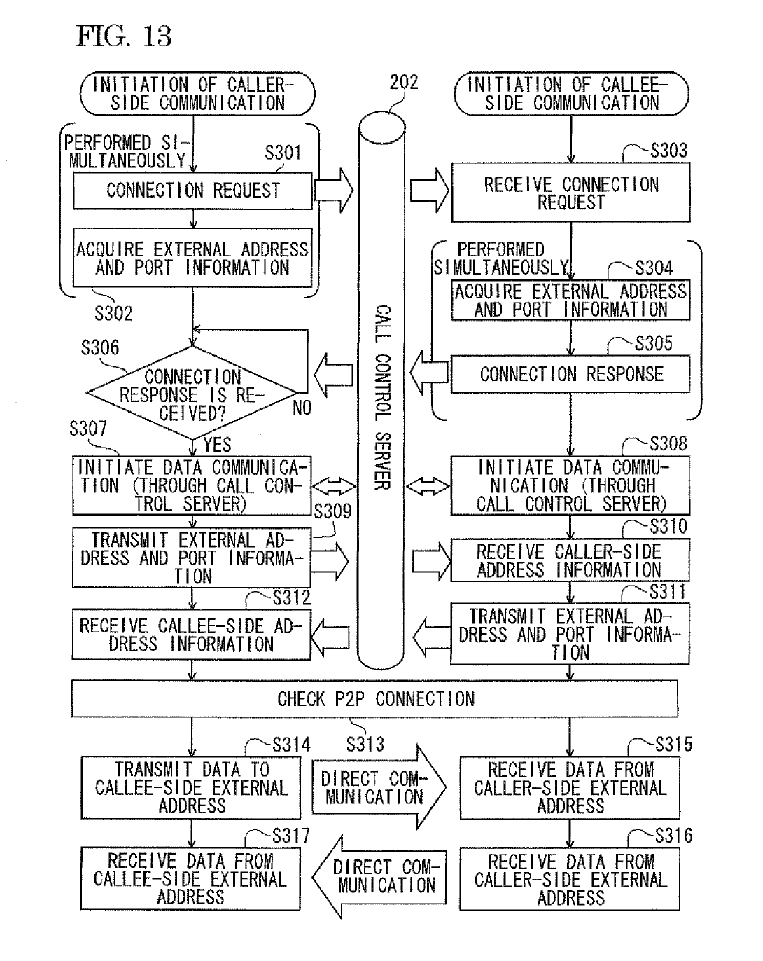

Next, FIG. 13 is a flowchart showing a processing procedure when establishing a VPN corresponding to the sequence diagram of FIG. 11. FIG. 13 shows a process in a network including a VPN device when a terminal 103 under the control of the VPN device 101 connects to a terminal 303 under the control of another VPN device 301 through the WAN 200.

First, similarly to the processing procedure of FIG. 11, the VPN devices 101 and 301 log into the call control server 202 and pass through user authentication, and the identification information and the like of the terminals 103 and 303 are registered and set to the call control server 202.

The VPN device 101 transmits a connection request to the VPN device 301 through the call control server 202 (step S301) and acquires the external address and port information of the subject device from the STUN server 201 (step S302). Upon receiving the connection request from the VPN device 101 (step S303), the VPN device 301 acquires the external address and port information of the subject device from the STUN server 201 (step S304) and transmits a connection response to the VPN device 101 through the call control server 202 (step S305).

The VPN device 101 determines whether a connection response is received from the VPN device 301 (step S306) and performs standby until the connection response is received if not received. When the VPN device 101 receives the connection response including a connection permission, the VPN devices 101 and 301 initiate data communication (actual data communication) through the call control server 202 (steps S307 and S308).

After the data communication is initiated, the VPN device 101 transmits the external address and port information of the VPN device 101 acquired from the STUN server 201 to the VPN device 301 through the call control server 202 (step S309). Moreover, the VPN device 301 receives the external address and port information of the VPN device 101 as caller-side address information (step S310). At the same time, the VPN device 301 transmits the external address and port information of the VPN device 301 acquired from the STUN server 201 to the VPN device 101 through the call control server 202 (step S311). Moreover, the VPN device 101 receives the external address and port information of the VPN device 301 as callee-side address information (S312).

Subsequently, the VPN devices 101 and 301 check whether P2P connection is possible using the received counterpart external address and port information (step S313). In this example, as described above, it is checked whether they are in the P2P communicable state.

When they are in the P2P communicable state, the VPN devices 101 and 301 initiate P2P communication. Specifically, the VPN device 101 performs data communication (actual data communication) by P2P communication to the VPN device 301 based on the external address and port information of the VPN device 301 (step S314). Moreover, the VPN device 301 receives data from the VPN device 101 (step S315). At the same time, the VPN device 301 performs data communication (actual data communication) by P2P communication to the VPN device 101 based on the external address and port information of the VPN device 101 (step S316). Moreover, the VPN device 101 receives data from the VPN device 301 (step S317).

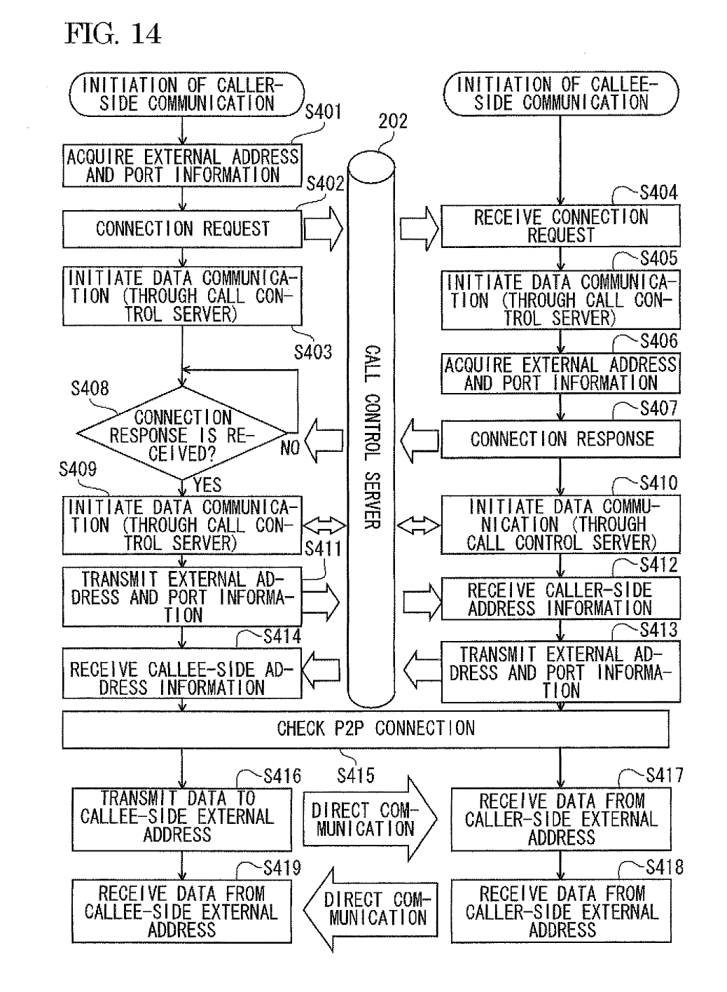

Next, FIG. 14 is a flowchart showing another processing procedure when establishing a VPN corresponding to the sequence diagram of FIG. 12. FIG. 14 shows a process in a network including a VPN device when a terminal 103 under the control of the VPN device 101 connects to a terminal 303 under the control of another VPN device 301 through the WAN 200.

First, similarly to the processing procedure of FIG. 12, the VPN devices 101 and 301 log into the call control server 202 and pass through user authentication, and the identification information and the like of the terminals 103 and 303 are registered and set to the call control server 202.

The VPN device 101 acquires the external address and port information of the subject device from the STUN server 201 (step S401). Subsequently, the VPN device 101 transmits a connection request to the VPN device 301 through the call control server 202 (step S402). Moreover, the VPN device 101 transmits a connection request and initiates data transmission (actual data transmission) to the VPN device 301 through the call control server 202 (step S403).

Upon receiving the connection request from the VPN device 101 (step S404), the VPN device 301 initiates data reception (actual data reception) from the VPN device 101 through the call control server 202 (step S405). Subsequently, the VPN device 301 acquires the external address and port information of the subject device from the STUN server 202 (step S406).

Subsequently, the VPN device 301 transmits a connection response to the VPN device 101 through the call control server 202 (step S407). When transmitting a connection response including a connection permission, the VPN device 301 initiates data communication (actual data communication) with the VPN device 101 through the call control server 202 (step S410).

The VPN device 101 determines whether a connection response is received from the VPN device 301 (step S408) and performs standby until the connection response is received if not received. Upon receiving the connection response including a connection permission, the VPN device 101 initiates data communication (actual data communication) with the VPN device 301 through the call control server 202 (step S409).

The processes after the VPN devices 101 and 301 initiate the data communication are the same as those of steps S309 to S317 of FIG. 13.

According to the VPN devices 101 and 301 of the second embodiment, since at least a part of actual data can be transmitted before checking whether they are in the P2P communicable state, which requires a predetermined period, it is possible to obviate the occurrence of a communication delay when P2P communication is performed between a plurality of VPN devices and to accelerate data communication.

(Modified Example of Second Embodiment)

In the above description, although a VPN device having a VPN function is disposed as an independent device, and terminals are disposed under the control thereof, only a VPN device (in this example, a terminal having the VPN function) may be disposed. In this example, only the difference from the VPN system shown in FIG. 1 and the VPN device shown in FIG. 3 will be described.

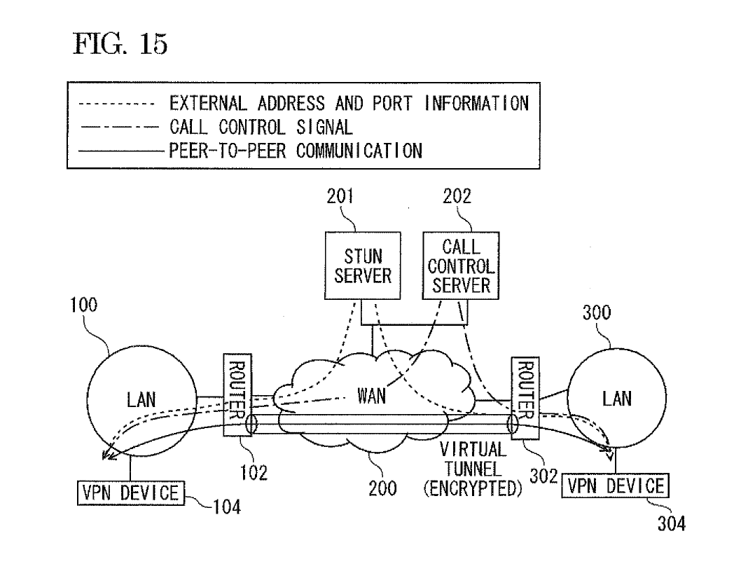

FIG. 15 is a diagram showing a modified configuration example of the VPN system according to the second embodiment of the invention. A difference from the configuration of the VPN system shown in FIG. 1 is that a VPN device 104 is provided instead of the VPN device 101 and the terminals 103 under the control thereof, and similarly, a VPN device 304 is provided instead of the VPN device 301 and the terminals 303 under the control thereof.

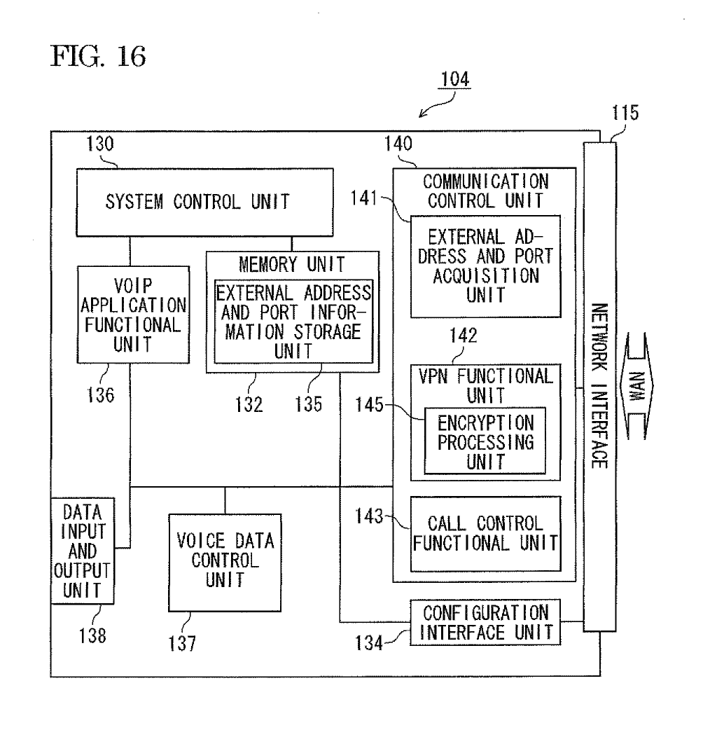

FIG. 16 is a block diagram showing a functional configuration example (modified configuration example) of the VPN device 104 of the present embodiment. In this example, only the difference from the VPN device 101 shown in FIG. 3 will be described.

The VPN device 104 does not include, as a functional configuration, the network interface 114, the subordinate terminal management unit 131, and the data relay unit 133, which are connected to a subordinate terminal, but includes a VoIP (Voice Over Internet Protocol) application functional unit 136, a voice data control unit 137, and a data input and output unit 138.

These respective functions are realized by the hardware operations or by the microcomputer 111 executing a predetermined program.

The VoIP application functional unit 136 executes various programs that realize the VoIP application function. The voice data control unit 137 controls voice data or the like which is transmitted and received to/from other terminals or input and output by the data input and output unit 138 by execution of various programs described above. The data input and output unit 138 is the function of a microphone, a speaker, an operation panel, and the like and inputs and output various data such as voice data.

Although it is assumed that the VPN device 104 has a voice call function by VoIP, the VPN device 104 may be a terminal that is designed to be used for the other VPN communication described above.

Moreover, although the processing procedure when establishing the VPN is basically similar to the processing procedure shown in FIGS. 11 to 14, the VPN device 104 performs the connection request by itself by the VoIP application functional unit 136 activating an application.

According to the VPN devices 104 and 304 of the present embodiment, it is possible to obviate the occurrence of a communication delay when P2P communication is performed between a plurality of VPN devices (in this example, terminals having the VPN function) without providing the VPN devices independently and to accelerate the data communication.

### Third Embodiment

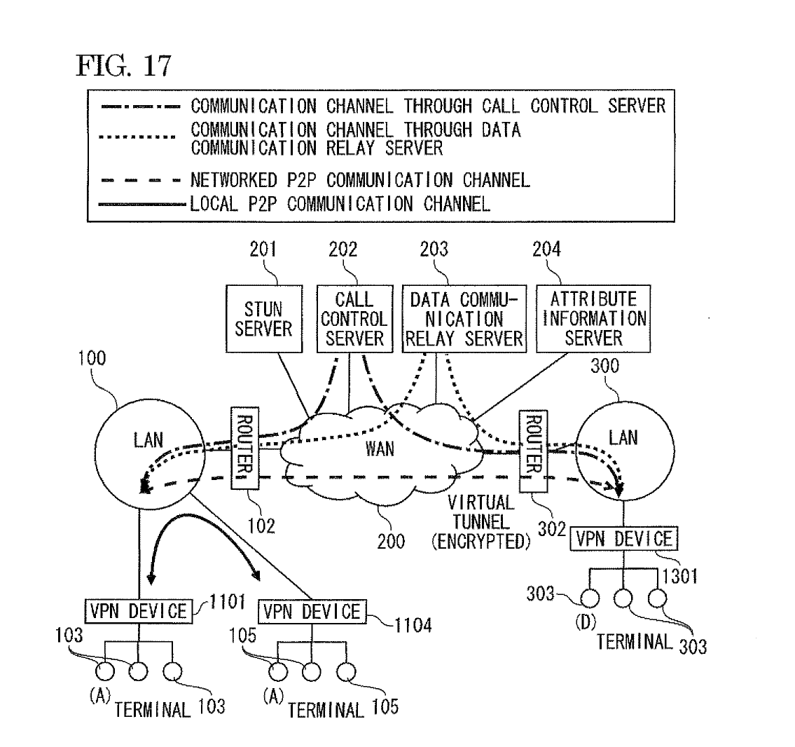

FIG. 17 is a diagram showing a configuration example of a VPN system according to the third embodiment of the invention. The VPN system of the present embodiment connects the communication channel of a local area network (LAN, local network) 100 deployed at one location and a LAN 300 deployed at the other location through a wide area network (WAN, global network) 200 such as the Internet. A wired LAN or a wireless LAN or the like is used as the LAN. The Internet or the like is used as the WAN. Moreover, the VPN system enables communication (hereinafter referred to as “VPN communication”) in which confidentiality is ensured by a virtual private network (VPN) between terminals 103 and 105 that are connected under the LAN 100 and terminals 303 that are connected under the LAN 300. As a specific use (application program or the like) of the VPN communication, IP telephony (voice call), net-meeting (video and voice communication), network camera (video transmission), and the like can be considered.

A router 102 is arranged at the boundary between the LAN 100 and the WAN 200, and a router 302 is arranged at the boundary between the WAN 200 and the LAN 300. Moreover, in the present embodiment, in order to enable establishment of a VPN, VPN devices 1101 and 1104 are connected to the LAN 100, and a VPN device 1301 is connected to the LAN 300. Moreover, the terminals 103 are connected under the VPN device 1101, the terminals 105 are connected under the VPN device 1104, and the terminals 303 are connected under the VPN device 1301. In addition, the number of VPN devices and terminals connected under the respective LANs is not limited to this, and for example, a plurality of VPN devices and terminals may be connected under the LAN 300.

On the WAN 200, a STUN server (Stun Server: SS) 201 and a call control server (Negotiation Server: NS) 202 are connected in order to enable VPN-based connection (hereinafter referred to as “VPN connection”) between the VPN device 1101 or 1104 and the VPN device 301. Moreover, a data communication relay server (Relay Server: RS) 203 and an attribute information server (Addressing Server: AS) 204 are also connected to the WAN 200.

The STUN server 201 is a server used to implement a STUN (Simple Traversal of User Datagram Protocol (UDP) through Network Address Translators (NATs)) protocol. The call control server 202 is a server used for making and receiving calls between peers such as VPN devices or terminals. The data communication relay server 203 has a function of relaying data communication between VPN devices. The attribute information server 204 stores attributes of the respective terminals and transmits attribute information (Configuration file) such as the attributes or the like of the terminals under the control of a VPN device that transmits an acquisition request, for example, in accordance with an acquisition request from the VPN device.

When the respective devices communicate through the WAN 200, global (external) address information which can be specified by the WAN is used on the WAN 200 as the address information for specifying the transmission source and transmission destination of packets to be transmitted. In general, since an IP network is used, a global IP address and a port number are used. However, in communications within the respective LANs 100 and 300, local (internal) address information which can be specified only within a LAN is used as the address information for specifying the transmission source and transmission destination. In general, since an IP network is used, a local IP address and a port number are used. Thus, in order to enable communication between the respective LANs 100 and 300 and the WAN 200, a NAT (Network Address Translation) function of performing interconversion between local address information and global address information is mounted on the respective routers 102 and 302. That is, an address conversion function performs interconversion corresponding to so-called NAPT (Network Address Port Translation) including the IP address of an IP network address and the port of a transport layer. In the following description of the invention, it is assumed that the NAT function means a broad sense of NAT function including a narrow sense of NAPT function.

However, the respective terminals under the LANs 100 and 300 do not possess global address information which can be accessed from the outside. Moreover, unless a special configuration is set, the terminals 103 or 105 under the LAN 100 are unable to communicate directly with the terminals 303 under the LAN 300. Moreover, due to the NAT function of the respective routers 102 and 302, in a normal state, the WAN 200 is unable to access the respective terminals in the respective LANs 100 and 300.

In such a situation, in the present embodiment, by providing the VPN devices 1101, 1104, and 1301 in the LANs at the respective locations, the LANs are connected through a VPN like a P2P communication channel indicated by the solid line in FIG. 17, so that the terminals 103 or 105 and the terminals 303 can directly communicate through a virtual closed communication channel. The configuration, function, and operation of the VPN device of the present embodiment will be described in the following order.

The STUN server 201 is an address information server that performs services regarding execution of a STUN protocol and provides information necessary for performing so-called communication over NAT. STUN is a standardized client-server Internet protocol used as one NAT traversal method in applications that perform bidirectional real-time IP communication of voice, video, text, or the like. In response to a request from an access source, the STUN server 201 transmits back external address and port information including information on external address and port as seen from an external network as global address information of the access source, which can be accessed from the outside. As the external address and port information, in an IP network, a global IP address and a port number are used.

The respective VPN devices 1101, 1104, and 1301 execute predetermined test procedure communication with the STUN server 201 and receive a response packet including the global IP address and port number of the respective terminals 103, 105, and 303 from the STUN server 201. In this way, the respective VPN devices 1101, 1104, and 1301 can acquire the global IP address and port number of the respective terminals 103, 105, and 303. Moreover, even when a plurality of routers is present between the LAN where a subject device is positioned and the WAN, and these routers or the like do not have an UPnP (Universal Plug and Play) function, it is possible to reliably acquire the global IP address and the port number.

As a method of allowing the VPN devices 1101, 1104, and 1301 to acquire the global IP address and port number, a method disclosed in IETF RFC 3489 (STUN—Simple Traversal of User Datagram Protocol (UDP) Through Network Address Translators (NATs)) may be used. However, the method based on STUN enables only the acquisition of a global IP address and a port number, whereas in the present embodiment, it is possible to establish a VPN in a simple and flexible manner without needing to perform an operation of configuring various parameters prior to communication.

The call control server 202 is a relay server that calls a specific counterpart to perform services regarding the control of calls between communication devices in order to establish a communication channel. The call control server 202 possesses identification information of VPN devices or terminals being registered and can call a specific counterpart based on a telephone number of a connection counterpart in the case of a communication system having an IP telephony function, for example. Moreover, the call control server 202 has a function of relaying signals or data and can transmit packets transmitted from a transmitter-side device to a receiver-side device and transmit packets transmitted from the receiver-side device to the transmitter-side device. Moreover, the call control server 202 can inform the respective terminals of information on the global IP address and port number of the data communication relay server 203 so that the respective terminals can access the data communication relay server 203.

In addition, in this example, although the STUN server 201 and the call control server 202 are configured as separate servers, they may be configured by one server, and the same functions may be mounted on any other server on a WAN.

The data communication relay server 203 has a function of relaying data communication between VPN devices. The data communication relay server 203 may be disposed plurally on the WAN 200, and may relay a plurality of data communications at the same time.

The attribute information server 204 transmits attribute information (Configuration file) in response to an acquisition reflected echo signal from a VPN device. The attribute information includes the setting information or operation information of the respective terminals, for example. Moreover, the attribute information may include the global IP address information and port number information of the data communication relay server 203 so that the respective terminals can access the data communication relay server 203.

Next, the communication channel when communication is performed between a plurality of VPN devices will be described. In the present embodiment, the following four clock communication channels (first to fourth communication channels) are considered. In FIG. 17, the first to fourth communication channels are depicted by bold solid lines or bold broken lines.

First, the first communication channel is a communication channel that involves the call control server 202. The call control server 202 is used to perform a process of establishing communication between VPN devices, and the first communication channel is used as an initial-stage communication channel for a predetermined period from the initiation of communication, for example.

The second communication channel is a communication channel that involves the data communication relay server 203. The second communication channel is used after the elapse of a predetermined period from the initiation of communication, for example. In this way, since the data communication relay server 203 has a lighter processing load than the call control server 202, it is possible to relay the communication between VPN devices at a higher speed than the communication through the call control server 202.

Moreover, the third communication channel is a communication channel (hereinafter referred to as a networked P2P communication channel) in which a VPN system is established by connecting the channels of two LANs 100 and 300 through the WAN 200, and direct communication is performed through a network. The third communication channel is used, for example, when communication is performed between the terminals 103 and 303 connected to different LANs 100 and 300, and the P2P communication is possible.

Moreover, the fourth communication channel is a communication channel (hereinafter referred to as a local P2P communication channel) in which terminals connected to the same LAN 100 perform direct communication without through an external network. The fourth communication channel is used, for example, when communication is performed between a terminal 103 under the control of the VPN device 1101 and a terminal 105 under the control of the VPN device 1104 connected to the same LAN 100.

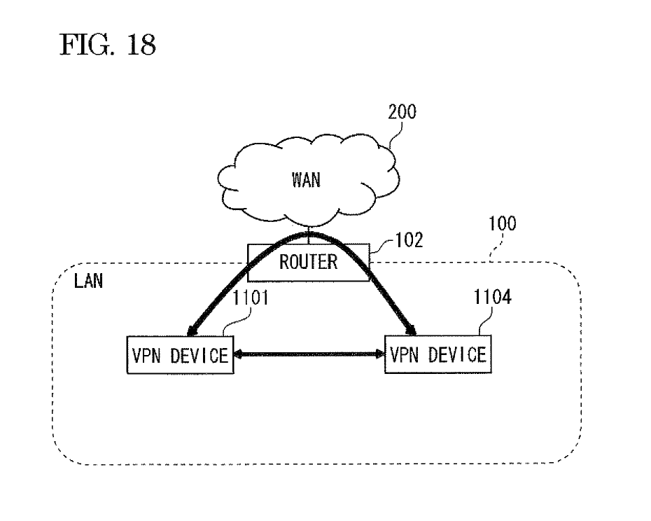

FIG. 18 is a diagram showing an example of communication (local P2P communication) performed between VPN devices connected to the same LAN. In this example, it is assumed that communication is performed between the VPN devices 1101 and 1104.

In the initial stage, the VPN devices 1101 and 1104 do not recognize that they are disposed in the same LAN 100. Thus, the VPN devices 1101 and 1104 try to transmit a packet to the WAN 200 using the external address and port information. Here, when the router 102 recognizes that the transmission destination address (for example, the global IP address) is a terminal under the control of the router 102 by referencing the communication data from the VPN devices 1101 and 1104, the router 102 does not transmit the communication data to an external network (in this example, the WAN 200) but transmits the data to the VPN devices 1104 and 1101 which, are the transmission destinations. This operation is referred to as a hairpinning operation.

Moreover, when the VPN devices 1101 and 1104 recognize that the counterpart devices are present in the same LAN 100, the VPN devices 1101 and 1104 may perform direct communication without through the router 102 using the information on the private IP address and port number of the counterpart devices. In this way, by performing direct communication without through the router 102, it is possible to decrease the number of relay instances by one, reduce a network load, and realize high-speed communication. Moreover, although some types of router 102 are not capable of performing the hairpinning operation, the local P2P communication can be performed regardless of the type of router 102.

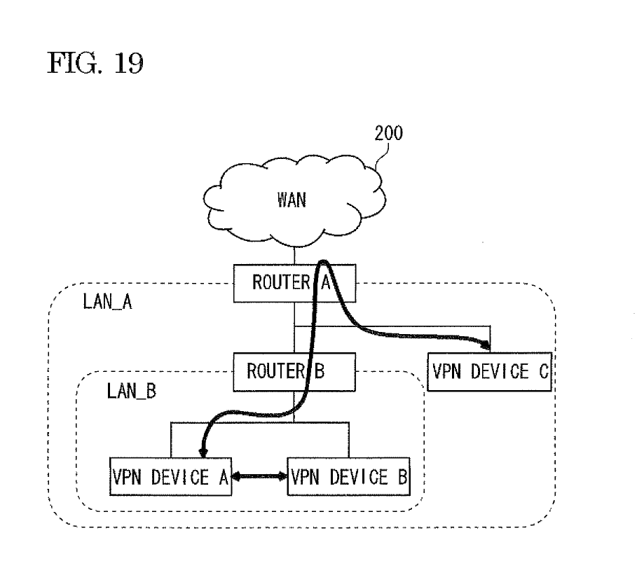

FIG. 19 is diagram showing an example of an environment in which routers are arranged in multiple stages within the same LAN. In the example shown in FIG. 19, a LAN_B is included in a LAN_A. A router A is connected to the LAN_A, and a router B is connected to the LAN_B. VPN devices A and B are disposed under the control of the router B. Moreover, a VPN device C is disposed outside the area of the LAN_B and under the control of the router A. In this example, it is assumed that communication is performed between the VPN devices A and C.

In the initial stage, the VPN devices A and C do not recognize that they are disposed in the same LAN_A. Thus, the VPN devices A and C try to transmit a packet to the WAN 200 using the external address and port information. Here, when the VPN device A recognizes that the transmission destination address (for example, the global IP address) is a terminal under the control of the router A, the VPN device A does not transmit communication data to an external network (in this example, the WAN 200) but transmits the data to the local IP address of the VPN device C which is the transmission destination. The VPN device C transmits back the received data to the transmission source. In this way, in an environment where routers are connected in multiple stages, it is possible to perform a direct P2P operation within the same LAN.

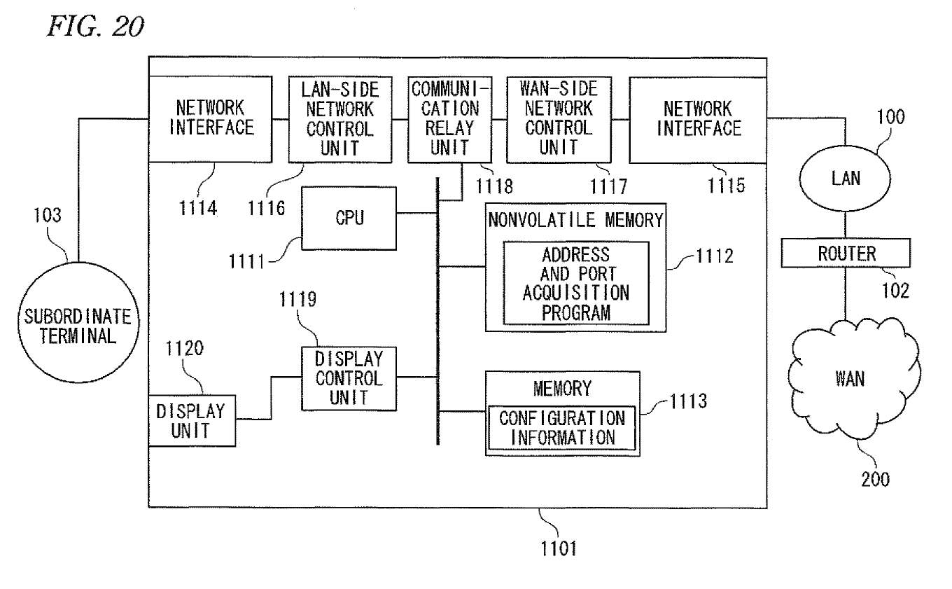

Next, the configuration and function of the VPN device according to the present embodiment will be described. Since the VPN devices 1101, 1104, and 1301 have the same configuration and function, the function and function of the VPN device 1101 will be described. FIG. 20 is a block diagram showing a configuration example of a hardware configuration of the VPN device of the present embodiment.

The VPN device 1101 is configured to include a microcomputer (CPU) 1111, a nonvolatile memory 1112 such as a flash RAM, a memory 1113 such as a SD RAM, a network interface 1114, a network interface 1115, a LAN-side network control unit 1116, a WAN-side network control unit 1117, a communication relay unit 1118, a display control unit 1119, and display unit 1120.

The microcomputer 1111 executes a predetermined program to thereby control the overall operation of the VPN device 101. The nonvolatile memory 1112 stores a program executed by the microcomputer 1111. The program includes an external address and port acquisition program for allowing the VPN device 101 to acquire the external address and port information and information on a private IP address.

The program executed by the microcomputer 111 may be acquired online from an external server through an arbitrary communication channel, and may be acquired by reading from a recording medium such as, for example, a memory card or a CD-ROM. In other words, a VPN device and a VPN networking method can be realized by allowing a general-purpose computer (the microcomputer 1111) to read a program for realizing the function of the VPN device from a recording medium.

When the microcomputer 1111 executes a program, a part of a program on the nonvolatile memory 1112 may be expanded onto the memory 1113, and the program on the memory 1113 may be executed.

The memory 1113 is one for managing data being operated by the VPN device 1101 and temporarily storing various setting information or the like. The setting information includes destination address information necessary for communication such as external address and port information included in the response to an external address and port acquisition request from a terminal. Moreover, information on the private IP address of the subject terminal may be included.

The network interface 1114 is an interface for connecting the VPN device 1101 and the subordinate terminals 103 managed by the subject device in a communicable state. The network interface 1115 is an interface for connecting the VPN device 1101 and the LAN 100 in a communicable state. The LAN-side network control unit 1116 is one that performs the communication control regarding the LAN-side network interface 1114. The WAN-side network control unit 1117 is one that performs the communication control regarding the WAN-side network interface 1115.

The communication relay unit 1118 relays packet data transmitted from a subordinate terminal 103 connected to the LAN side to an external VPN connection destination (a terminal 303 under the control of the VPN device 1301) or a VPN connection destination (a terminal 105 under the control of the VPN device 1104) within the same LAN, and conversely, relays packet data that is transmitted from the external VPN connection destination (the terminal 303 under the control of the VPN device 1301) or the VPN connection destination (the terminal 105 under the control of the VPN device 1104) within the same LAN and arrived at the subordinate terminal 103.

The display unit 1120 is configured by a display that displays the operation state or the like of the VPN device 1101 and informs a user or an administrator of various states. The display unit 1120 is configured by a plurality of light-emitting diodes (LEDs), a liquid crystal display (LCD), or the like. The display control unit 1119 performs the display control of the display unit 1120 and controls the content or the like displayed on the display unit 1120 in accordance with a display signal from the microcomputer 1111.

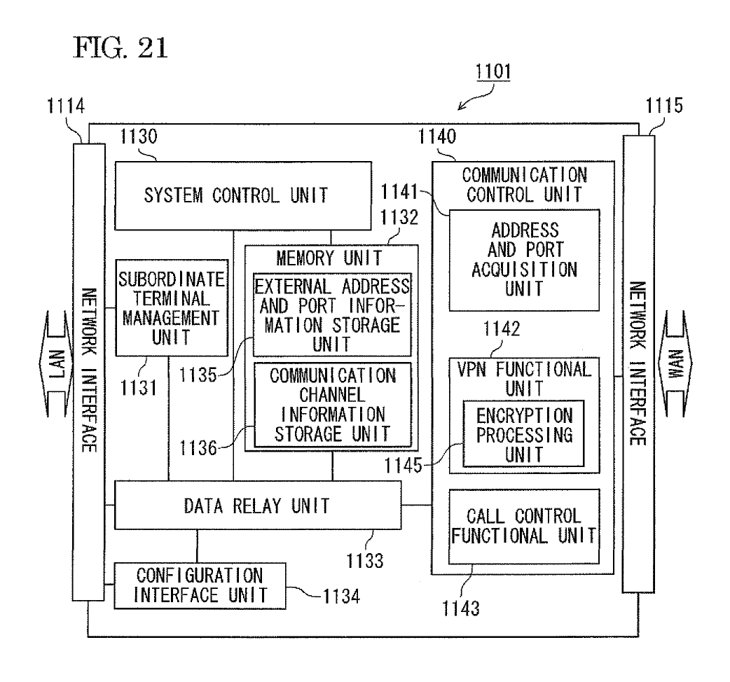

FIG. 21 is a block diagram showing a functional configuration example of the VPN device of the present embodiment.

The VPN device 1101 is configured to include, as its functional configuration, a system control unit 1130, a subordinate terminal management unit 1131, a memory unit 1132, a data relay unit 1133, a configuration interface unit 1134, and a communication control unit 1140. The memory unit 1132 includes an external address and port information storage unit 1135 and a communication channel information storage unit 1136. The communication control unit 1140 includes an external address and port acquisition unit 1141, a VPN functional unit 1142, and a call control functional unit 1143. The VPN functional unit 1142 includes an encryption processing unit 1145. These respective functions are realized by the hardware operations of the respective blocks shown in FIG. 20 or by the microcomputer 1111 executing a predetermined program.

The LAN-side network interface 1114 of the VPN device 1101 is connected to the subordinate terminals 103, and the WAN-side network interface 1115 is connected to the WAN 200 through the LAN 100 and the router 102.

The system control unit 1130 controls the overall operation of the VPN device 1101. The subordinate terminal management unit 1131 manages the terminals 103 under the VPN device 1101. The memory unit 1132 stores external address and port information including information on external address (the global IP address on the WAN 200) and port (port number of an IP network) and private IP address information in the external address and port information storage unit 1135. As the external address and port information and the private IP address information, the global IP address and port number and the private IP address information allocated to a subordinate terminal 103 which is a connection source, information on a global IP address and a port number allocated to a connection destination terminal 303 or 105, the private IP address information allocated to the connection destination terminal 105, and the like are stored.

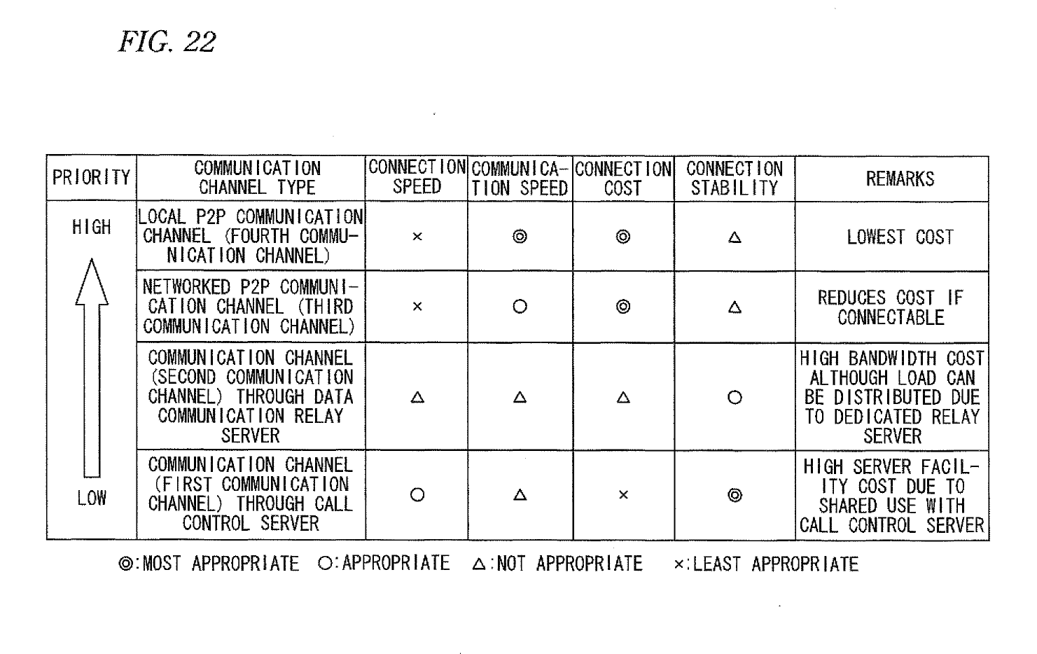

Moreover, the memory unit 1132 stores information on the plurality of communication channels (for example, the first to fourth communication channels) that communicably connects the VPN device 1101 and the VPN device 1301 or 1104 and evaluation information of the respective communication channels in the communication channel information storage unit 1136. FIG. 22 is a diagram showing an example of information (communication channel information) stored in the communication channel information storage unit 1136. The communication channel information storage unit 1136 includes information such as priority, channel type, connection speed, communication speed, connection cost, and connection stability of each communication channel as the communication channel information. Among them, priority, connection speed, communication speed, connection cost, connection stability, and the like are examples of evaluation information. Although four steps of indices of most appropriate, appropriate, not appropriate, and least appropriate are stored in the example shown in FIG. 6, the invention is not limited to this, and specific values may be stored. For example, a bit rate, a baud rate, an error rate, a retransmission frequency, the number of relays relaying communication, a communication charge, and the like may be stored. Moreover, the communication channel information may be optionally set through an operation unit or the like as necessary in accordance with an instruction of a user.

The data relay unit 1133 relays packets transmitted from a connection source terminal 103 to a connection destination terminal 303 or 105, and conversely, packets transmitted from the connection destination terminal 303 or 105 to the connection source terminal 103. The configuration interface unit 1134 is a user interface for allowing a user or an administrator to perform various operations such as setting operations on the VPN device 1101. As a specific example of the user interface, a Web page or the like that displays information using a browser operating on a terminal is used.

The external address and port acquisition unit 1141 of the communication control unit 1140 acquires the external address and port information allocated to the subordinate terminals 103 of the VPN device 1101 from the STUN server 201. Moreover, the external address and port acquisition unit 1141 receives packets including the external address and port information of the connection destination terminal 303 or 105 through the call control server 202 to acquire the external address and port information allocated to the connection destination terminal 303 or 105. Moreover, the external address and port acquisition unit 1141 acquires packets including the private IP address of the connection destination terminal 105 through the call control server 202, for example. The information acquired by the external address and port acquisition unit 1141 is stored in the external address and port information storage unit 1135 of the memory unit 1132.

The VPN functional unit 1142 of the communication control unit 1140 performs an encryption process necessary for VPN communication on the encryption processing unit 1145. That is, the encryption processing unit 1145 encapsulates and encrypts packets to be transmitted and uncapsulates and decrypts received packets to extract original packets. In addition, the VPN device 1101 may perform client-server communication by the first and second communication channels where packets are relayed by the call control server 202 or the data communication relay server 203 as well as the P2P communication by the third and fourth communication channels described above. In the former case, encryption may be performed on the server side.

The call control functional unit 1143 performs a process of transmitting a connection request for connecting to a target connection destination to the call control server 202 and a process of receiving a connection response from the connection destination through the call control server 202. Moreover, the call control functional unit 1143 determines whether the VPN device 1101 and the VPN device 1301 or 1104 are in the connectable state by any one of the first to fourth communication channels.

Moreover, the call control functional unit 1143 sets a specific communication channel to be used among the communication channels determined to be in the connectable state by referencing the evaluation information of the communication channel information stored in the communication channel information storage unit 1136. For example, when all the first to fourth communication channels are in the connectable state, the local P2P communication channel which is the fourth communication channel is set as the communication channel to be used. Moreover, when connection by the P2P communication through a network and the local P2P communication is not possible, the communication channel through the data communication relay server 203 which is the second communication channel is set as the communication channel to be used.

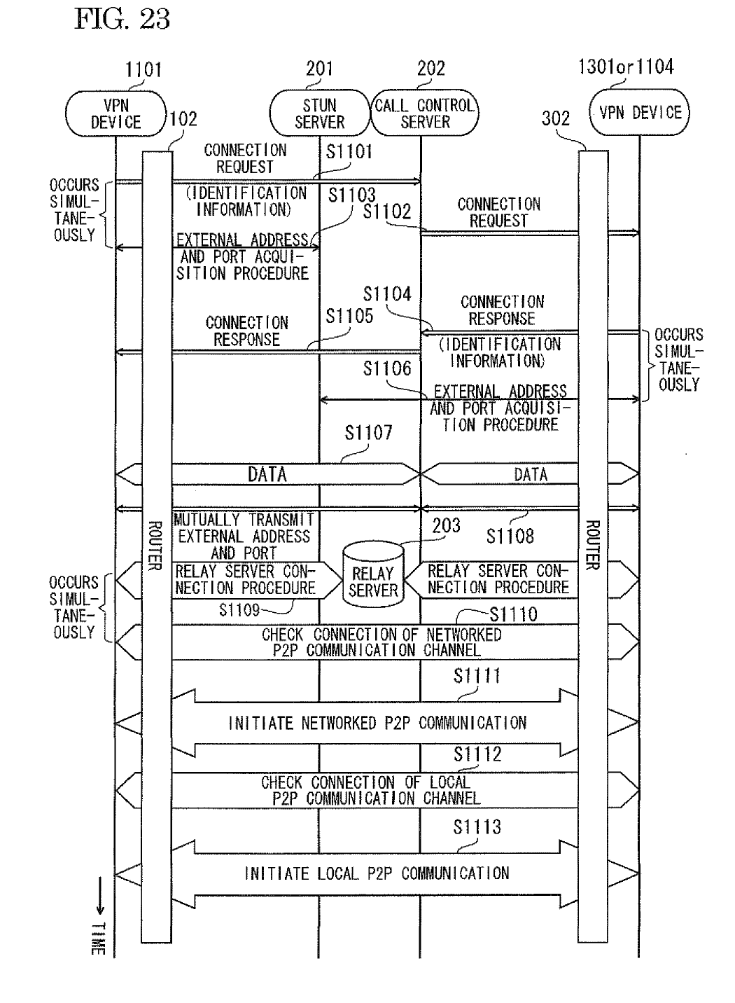

Next, the operation of the VPN device 1101 of the present embodiment when establishing a VPN will be described. FIG. 23 is a sequence diagram showing a processing procedure when the VPN system of the present embodiment establishes a VPN. FIG. 23 shows a process in a network including a VPN device when a terminal 103 under the control of the VPN device 1101 connects to a terminal 303 under the control of another VPN device 1301 or a terminal 105 under the control of another VPN device 1104 through the WAN 200. In this example, although a procedure of establishing a communication channel in the ascending order of the priority included in the communication channel information stored in the communication channel information storage unit 1136 is described as an example, the procedure of establishing a communication channel is not limited to this.

First, prior to the process shown in FIG. 23, the VPN device 1101 logs into the call control server 202 and passes through user authentication. When the VPN device 1101 succeeds in the user authentication, the identification information (MAC address, user ID, telephone number, or the like) of the VPN device 1101, position information (global IP address) on a network, and the like are registered and set to the call control server 202. After that, the VPN device 1101 and the call control server 202 can communicate with each other. Although the VPN device 1101 is a caller side, the VPN device 1301 or 1104 which is the callee side also logs into the call control server 202 and passes through user authentication, and the identification information or the like of the VPN device 1301 or 1104 is registered and set to the call control server 202.

In this state, upon receiving a VPN connection request from the subordinate terminal 103, the VPN device 1101 transmits a connection request to the call control server 202 to establish a networked P2P communication channel to the VPN device 1301 having the connection destination terminal 303 under the control thereof or the VPN device 1104 having the connection destination terminal 105 under the control thereof by the function of the external address and port acquisition unit 1141 upon activation of an application that performs VPN communication (step S1101). In this case, the VPN device 1101 transmits a connection request including the caller and callee-side identification information to the call control server 202. The call control server 202 relays and transmits the connection request to the VPN device 1301 or 1104 which is the connection destination of the VPN connection (step S1102). With this connection request, the call control server 202 informs the connection destination of a request that the VPN device 1101 wants to make VPN connection to the VPN device 1301 or 1104 to establish a networked P2P channel.

Concurrently with the connection request by the VPN device 1101, the VPN device 1101 performs an external address and port acquisition procedure with the STUN server 201 (step S103). In this case, the VPN device 1101 transmits a binding request (connection request, see RFC 3489; the same herein below) packet to the STUN server 201 as an external address and port acquisition request in order to acquire the external address and port information (the global IP address and port number as seen from the WAN 200 side) allocated to the terminal 103. On the other hand, in response to the external address and port acquisition request, the STUN server 201 transmits back a binding response (connection response, see RFC 3489: the same herein below) packet to the VPN device 1101 as an external address and port information response. Moreover, the VPN device 1101 stores the external address and port information obtained by the external address and port information response.

Upon receiving the connection request from the call control server 202, the connection destination VPN device 1301 or 1104 transmits a connection response to the connection request to the call control server 202 (step S1104). In this case, the VPN device 1301 or 1104 transmits a connection response including the caller and callee-side identification information to the call control server 202. The call control server 202 relays and transmits the connection response to the VPN device 1101 which is a connection requester of the VPN connection (step S1105). With this connection response, the call control server 202 informs the connection requester of a response to the connection request from the VPN device 1301 or 1104 to the VPN device 1101.

Concurrently with the connection response by the VPN device 1301 or 1104, the VPN device 1301 or 1401 performs an external address and port acquisition procedure with the STUN server 201 (step S1106). In this case, similarly to the VPN device 1101, the VPN device 1301 or 1104 transmits a binding request packet to the STUN server 201 as an external address and port acquisition request in order to acquire the external address and port information (the global IP address and port number as seen from the WAN 200 side) allocated to the terminal 303 or 105. On the other hand, in response to the external address and port acquisition request, the STUN server 201 transmits back a binding response packet to the VPN device 1301 or 1104 as an external address and port information response. Moreover, the VPN device 1301 or 1104 stores the external address and port information obtained by the external address and port information response.

When the VPN device 1101 receives a connection response including a connection permission from the VPN device 1301 or 1104, the VPN devices 1101 and the VPN device 1301 or 1104 communicate actual data (voice packets, video packets, and the like) through the call control server 202 (step S1107). That is, actual data communication is initiated before the networked P2P communication channel is established.

Subsequently, the VPN device 1101 and the VPN device 1301 or 1104 inform the counterpart devices of the external address and port information of the terminal 103 and the terminal 303 or 105 acquired from the STUN server 201 through the call control server 202 (step S1108).

Subsequently, the VPN device 1101 and the VPN device 1301 or 1104 switch from the actual data communication through the call control server 202 to actual data communication through the data communication relay server 203 (step S1109). The information on the global IP address and port number of the data communication relay server 203 may be understood by acquiring the attribute information including various information (including the information on the global IP address and printing speed) of the data communication relay server 203 from the attribute information server 204. Moreover, whenever the actual data communication is switched to the data communication relay server 203, the call control server 202 may inform the VPN device 1101 and the VPN device 1301 or 1104 of the information on the port number of the data communication relay server 203.

Concurrently with the switching from the call control server 202 to the data communication relay server 203, the VPN device 1101 and the VPN device 1301 or 1104 determine whether there are in a state where networked P2P communication can be performed between the terminal 103 and the terminal 303 or 105 using the received external address and port information of the terminal 103 and the terminal 303 or 105 (step S1110). In this example, the VPN device 1101 and the VPN device 1301 or 1104 set the external address and port information (the global IP address and port number) of the counterpart devices as a transmission destination to transmit packets through the WAN 200, and check communicability. For example, the VPN device 1101 transmits a packet to the VPN device 1301 or 1104, and when a response indicating the receipt of the packet is received from the VPN device 1301 or 1104 within a predetermined period from the transmission, it is determined that they are in the networked P2P communicable state.

For example, the networked P2P communicability is determined by the type of NAT function of the routers 102 and 302. The NAT function is categorized into four types of FC (Full Cone NAT), AR (Address-Restricted cone NAT), PR (Port-Restricted cone NAT), and SYN (Symmetric NAT). Among them, the networked P2P communication is not possible if both of the routers 102 and 302 are SYN, or one is PR and the other is SYN. In the other combinations, the networked P2P communication can be performed between the terminal 103 and the terminal 303 or 105.

When they are in the networked P2P communicable state, since the networked P2P communication channel is established, the VPN device 101 and the VPN device 301 or 104 initiate encrypted actual data communication by the networked P2P communication (step S1111).

Furthermore, the VPN device 1101 and the VPN device 1301 or 1104 determine whether they are in a state where local P2P communication can be performed (step S1112).

In this case, first, the VPN device 101 determines whether the global IP address of the terminal 303 or 105 is the same as that of the terminal 103 by referencing the external address and port information of the connection destination terminal 303 or 105. When the global IP addresses are the same, the VPN device 1101 recognizes that the connection destination of the terminal 103 is a connection destination within the same LAN, namely the terminal 105 under the control of the VPN device 1104.

Moreover, the VPN device 1101 transmits a packet to the VPN device 1104 using the information on the private IP address and port number of the terminal 105, and when a response indicating the receipt of the packet from the VPN device 1104 within a predetermined period from the transmission, it is determined that they are in the local P2P communicable state. Here, the port number information has been acquired when they transmitted the mutual external address and port information. The private IP address information may be transmitted when the mutual external address and port information is transmitted in step S1108, and may be transmitted together with actual data when communication (the communication in steps S1107, S1109, and S1111) by any of the communication channels is being performed. That is, the mutual private IP address information is transmitted before the local P2P communication is initiated.

When the local P2P communication is possible, the terminals 103 and 105 switch from the networked P2P communication to the local P2P communication to initiate the local P2P communication (step S1113). When the local P2P communication is performed, the information on the private IP addresses and port numbers of the terminals 103 and 105 is used.

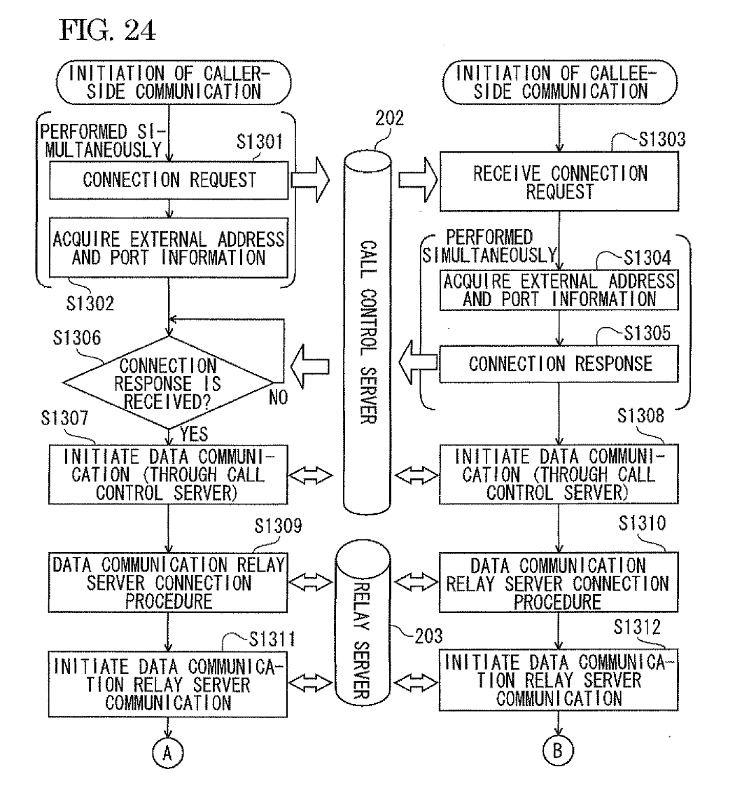

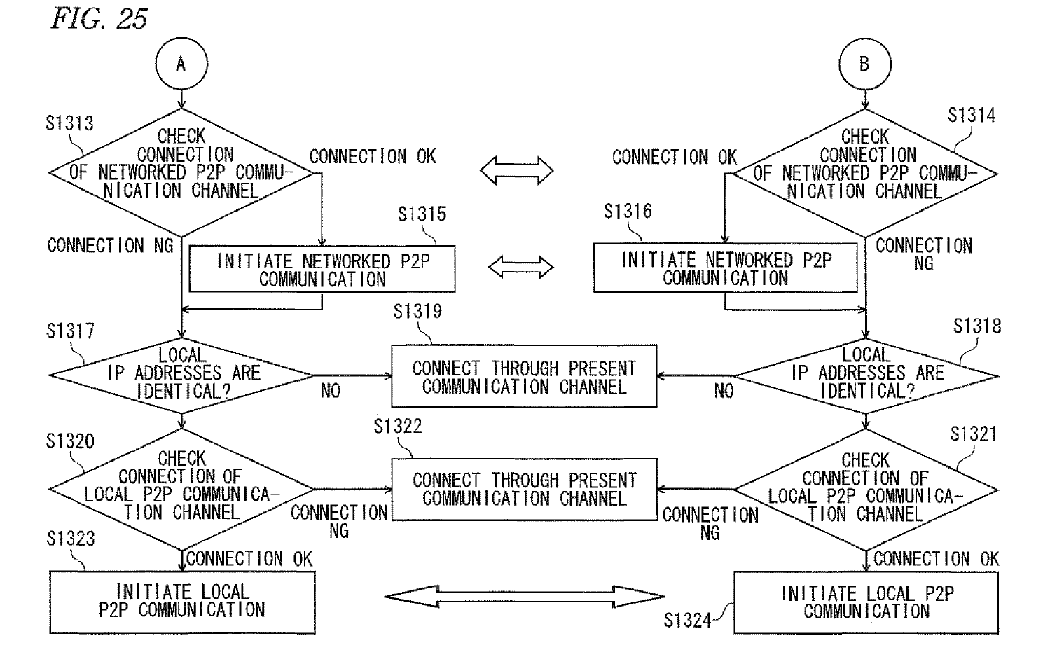

Next, FIGS. 24 and 25 are flowcharts showing a processing procedure when establishing a VPN corresponding to the sequence diagram of FIG. 23.

FIGS. 24 and 25 show a process in a network including a VPN device when a terminal 103 under the control of the VPN device 1101 connects to a terminal 303 under the control of another VPN device 1301 or a terminal 105 under the control of another VPN device 1104 through the WAN 200.

First, similarly to the processing procedure of FIG. 23, the VPN device 1101 and the VPN device 1301 or 1104 log into the call control server 202 and pass through user authentication, and the identification information and the like of the VPN device 1101 and the VPN device 1301 or 1104 are registered and set to the call control server 202.

The VPN device 1101 transmits a connection request to the VPN device 1301 or 1104 through the call control server 202 (step S1301) and acquires the external address and port information of the terminal 103 from the STUN server 201 (step S1302). Upon receiving the connection request from the VPN device 1101 (step S1303), the VPN device 1301 or 1104 acquires the external address and port information of the terminal 303 or 105 from the STUN server 201 (step S1304) and transmits a connection response to the VPN device 1101 through the call control server 202 (step S1305).

The VPN device 1101 determines whether a connection response is received from the VPN device 1301 or 1104 (step S1306) and performs standby until the connection response is received if not received. When the VPN device 1101 receives the connection response including a connection permission, the VPN device 1101 and the VPN device 1301 or 1104 initiate data communication (actual data communication) through the call control server 202 (steps S1307 and S1308).

After the data communication through the call control server 202 is initiated, the VPN device 1101 and the VPN device 1301 or 1104 executes a procedure to connect to the data communication relay server 203 (steps S1309 and S1310). In this example, the information on the global IP address and port number of the data communication relay server 203 is acquired from the call control server 202 or the attribute information server 204. Moreover, the VPN device 1101 and the VPN device 1301 or 1104 set the acquired global IP address and port number of the data communication relay server 203 as a relay destination and initiate data communication through the relay server 203 (steps S1311 and S1312). That is, the actual data communication is switched from the call control server 202 to the data communication relay server 203. After the switching, the data communication through the call control server 202 is terminated.

After the data communication through the data communication relay server 203 is initiated, the VPN device 1101 and the VPN device 1301 or 1104 checks the connectability of the networked P2P communication using the receive counterpart external address and port information (steps S1313 and S1314). In this example, it is determined whether the networked P2P communication is possible. When the networked P2P communication is possible, the terminal 103 and the terminal 303 or 105 initiate networked P2P communication (steps S1315 and S1316).

Subsequently, during the data communication through the data communication relay server 203 or the networked P2P communication, the VPN device 101 and the VPN device 301 or 104 determine whether the global IP addresses of the communication counterparts are identical to the global IP addresses of the terminal 103 and the terminal 303 or 105 (steps S1317 and S1318). When the mutual global IP addresses are different from each other, it means that the VPN devices 101 and 301 are arranged in different LANs 100 and 300. In this case, the terminals 103 and 303 continue the data communication using the present communication channel (namely, the communication through the data communication relay server 203 or the networked P2P communication) (step S1319).

On the other hand, when the mutual global IP addresses are identical, it means that the communication is performed between the terminals 103 and 105 under the control of the VPN devices 101 and 104 within the same LAN 100. In this case, the VPN devices 1101 and 1104 transmit the private IP address information to the counterpart devices through the call control server 202, for example, and check the connectability of the local P2P communication channel using the information on the received private IP addresses and port numbers of the terminals 103 and 105 under the control of the counterpart VPN devices (steps S1320 and S1321). When the local P2P communication channel is not possible, the VPN devices 1101 and 1104 continue the data communication using the present communication channel (namely, the communication through the data communication relay server 203 or the networked P2P communication) (step S1322). On the other hand, when the local P2P communication is possible, the terminals 103 and 105 initiate local P2P communication (steps S1323 and S1324).

According to the processing procedures of FIGS. 23 and 24, it is possible to preferentially set the communication channel having the higher priority shown in the communication channel information stored in the communication channel information storage unit 1136. Thus, it is possible to set the most appropriate communication channel in an environment where a VPN device that tries to perform communication is placed.

### Fourth Embodiment

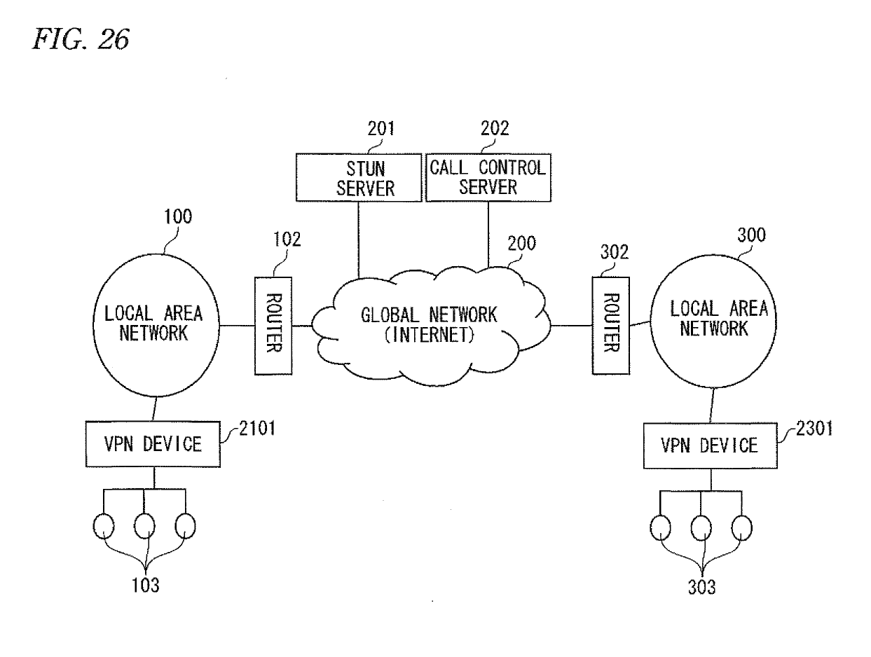

FIG. 26 is a diagram showing a configuration example of a VPN system according to the fourth embodiment of the invention. In the configuration example shown in FIG. 26, a case in which secure communication is enabled between a terminal 103 connected under the control of a local area network (hereinafter referred to as a LAN) 100 deployed at one location and a terminal 303 connected under the control of a LAN 300 deployed at the other location through a wide area network (hereinafter referred to as a WAN) 200 such as the Internet is considered. As a specific use (classification of application program or the like) of the VPN communication, IP telephony (voice call), net-meeting (video and voice communication), network camera (video transmission), and the like can be considered. Moreover, the LANs 100 and 300 are networks established by the Ethernet (registered trademark) in a certain location or in one department of a certain office.

As shown in FIG. 26, a router 102 is provided between the LAN 100 and the WAN 200, and a router 302 is provided between the WAN 200 and the local area network 300. Moreover, in order to enable virtual private network (VPN) connection, a VPN device 2101 is connected between the LAN 100 and the terminal 103, and a VPN device 2301 is provided between the local area network 300 and the terminal 303. In addition, the VPN devices 2101 and 2301 have a function of a communication relay device (router).

When the terminals 103 and 303 perform communication through the WAN 200, a global IP address is used on the WAN 200 as the address information for specifying the transmission source and transmission destination of packets to be transmitted. However, in communications on the respective LANs 100 and 300, a local IP address is used as the address information for specifying the transmission source and transmission destination. Thus, in order to enable communication between the respective LANs 100 and 300 and the WAN 200, a NAT (Network Address Translation) function of performing interconversion between local address information and global address information is mounted on the respective routers 102 and 302. By the NAT function of the routers 102 and 302, the terminals 103 and 303 can perform communication without being particularly aware of the global IP address and local IP address.

However, unless special control is performed, the terminals 103 and 303 under the control of the LANs 100 and 300 cannot be aware of the global address information allocated to themselves. Moreover, for example, a terminal 103 belonging to the LAN 100 cannot directly connect to a terminal 303 belonging to another LAN 300. This is because the terminal does not know the address information for accessing a connection counterpart. Moreover, due to the NAT function of the respective routers 102 and 302, in a normal state, the WAN 200 is unable to access the respective LANs 100 and 300.

In such a situation, by connecting the VPN devices 2101 and 2301 serving as a relay device to the LANs at the respective locations, direct communication (P2P communication) can be performed between the terminals 103 and 303. Moreover, in order to enable such communication, a STUN server 201 and a call control server 202 are connected to the WAN 200.

In addition, the STUN server 201 and the call control server 202 can be substituted with other devices performing the same functions.

The STUN server 201 is a server necessary for executing a STUN (Simple Traversal of UDP through NATs [RFC 3489]) protocol. STUN is a standardized client-server Internet protocol used as one NAT traversal method in applications that perform bidirectional real-time IP communication of voice, video, text, or the like.

The respective VPN devices 2101 and 2301 execute predetermined test procedure communication with the STUN server 201 and receive a response packet including the global addresses of the terminals 103 and 303 under the control of the VPN devices 101 and 301 from the STUN server 201. In this way, the respective VPN devices 2101 and 2301 can acquire the global addresses of the subordinate terminals 103 and 303. Moreover, even when a plurality of routers 102 and 302 is present between the LAN where the VPN devices 2101 and 2301 are positioned and the WAN, and the routers 102 and 302 do not have an UPnP (Universal Plug and Play) function, it is possible to reliably acquire the global addresses.

As a method of allowing the VPN devices 2101 and 2301 to acquire the global IP addresses, a method disclosed in IETF RFC 3489 (STUN—Simple Traversal of User Datagram Protocol (UDP) Through Network Address Translators (NATs)) may be used.

The call control server 202 is a server that performs control in order to call a specific communication counterpart. For example, when a communication system has an IP telephony function, the call control server 202 can call a specific counterpart based on a telephone number of a connection counterpart. Moreover, the call control server 202 has a function of relaying signals or data (see 3WHS described above) and can transmit packets transmitted from the terminal 103 to the terminal 303 through the WAN 200 and transmit packets transmitted from the terminal 303 to the terminal 103 through the WAN 200.

Next, the VPN devices 2101 and 2301 will be described.

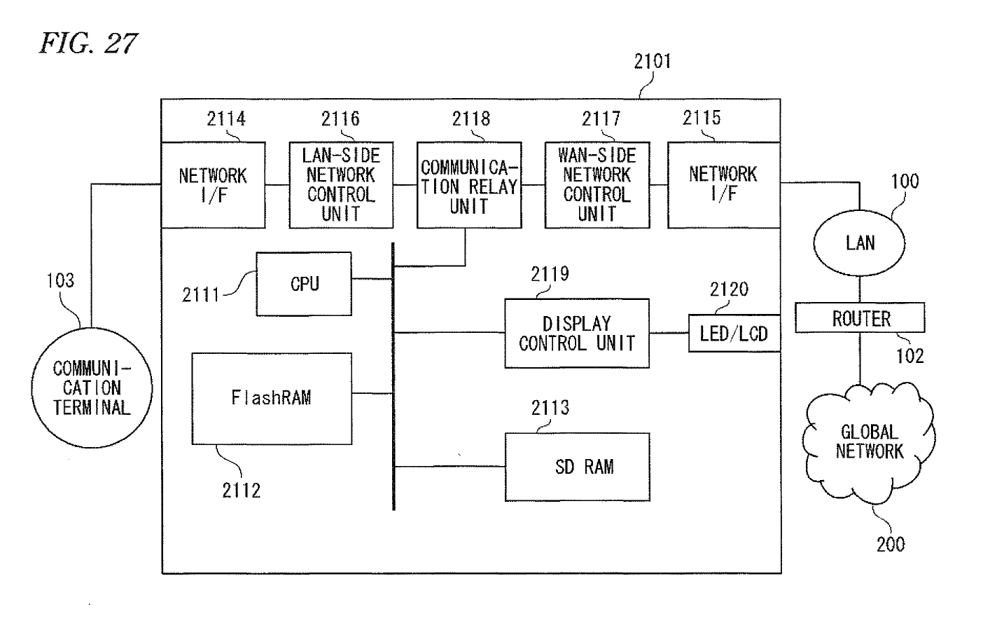

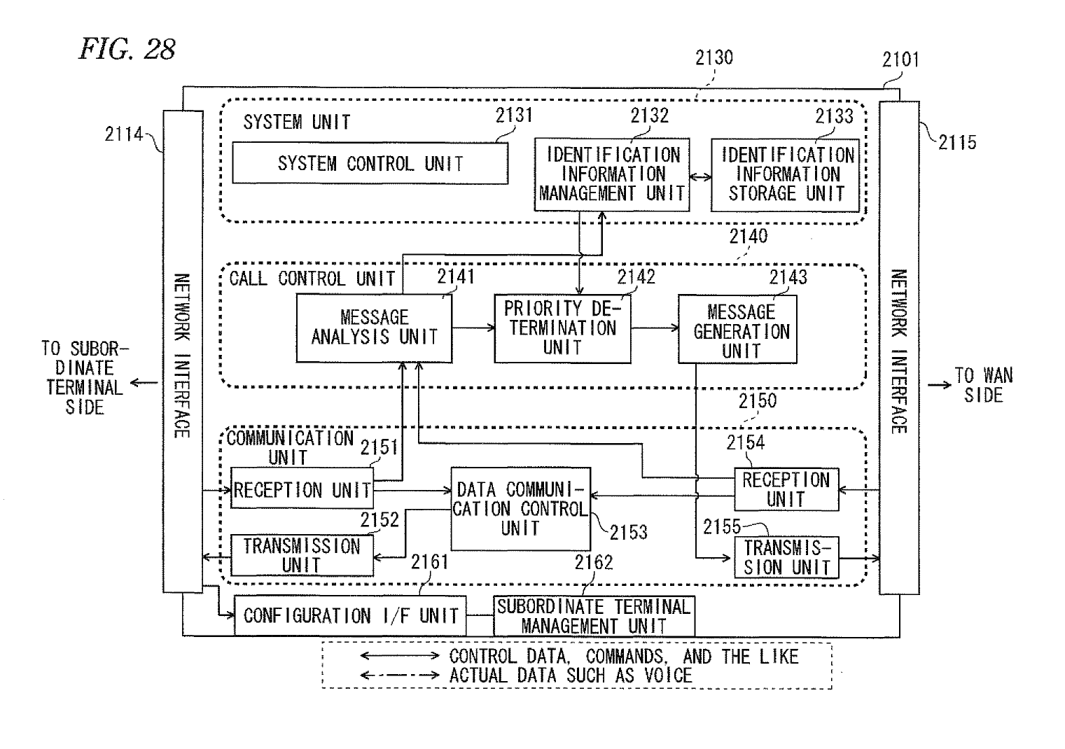

The VPN devices 2101 and 2301 have the same configuration and function. In this example, the VPN device 2101 will be described. FIG. 27 is a diagram showing an example of a hardware configuration of the VPN device 2101, and. FIG. 28 is a diagram showing an example of a functional configuration of the VPN device 2101.

As a hardware configuration, as shown in FIG. 27, the VPN device 2101 includes a microcomputer (CPU) 2111, a nonvolatile memory (flash RAM) 2112, a memory (SD RAM) 2113, network interfaces (I/F) 2114 and 2115, network control units 2116 and 2117, a communication relay unit 2118, a display control unit 2119, and a display 2120.

The CPU 2111 executes a predetermined program to thereby control the overall operation of the VPN device 2101.

The nonvolatile memory 2112 stores a program executed by the microcomputer 2111, operation data, management information for performing call control, and a control program. The program includes a program for determining cross calls described later. The program executed by the CPU 2111 may be acquired online from an external server through an arbitrary communication channel, and may be acquired by reading from a recording medium such as, for example, a memory card or a CD-ROM. Moreover, when the CPU 2111 executes a program, a part of a program on the nonvolatile memory 2112 may be expanded onto the memory 2113, and the program on the memory 2113 may be executed.

The memory 2113 stores identification information (the identification information of the invention, details of which will be described later) of the VPN device 2101.

The network interface 2114 is used for connecting the VPN device 2101 and the subordinate terminals 103 in a communicable state. The network interface 2115 is used for connecting the VPN device 2101 and the local network 100 in a communicable state.

The network control unit 2116 performs the communication control regarding the network interface 2114. The network control unit 2117 performs the communication control regarding the network interface 2115.

The communication relay unit 2118 relays packet data transmitted from a subordinate terminal 103 connected to the LAN side to a terminal 303 under the control of the external VPN device 2301. Moreover, the communication relay unit 2118 relays packet data that is transmitted from the terminal 303 under the control of the external VPN device 2301 and arrived at the terminal 103 under the control of the VPN device 2101.

The display 2120 is a display control unit for informing a user or an administrator of various states needed by the VPN device 2101 and is configured by a light-emitting diode (LED) or a liquid crystal display (LCD).

The display control unit 2119 controls the content displayed on the display 2120.

Moreover, as a functional configuration, as shown in FIG. 28, the VPN device 2101 includes a system unit 2130, a call control unit 2140, a communication unit 2150, a setting interface (I/F) 2161, and a subordinate terminal management unit 2162. Moreover, the system unit 2130 includes a system control unit 2131, an identification information management unit 2132, and an identification information storage unit 2133. Moreover, the call control unit 2140 includes a message analyzing unit 2141, a priority determination unit 2142, and a message generation unit 2143. Moreover, the communication unit 2150 includes reception units 2151 and 2154, transmission units 2152 and 2155, and a data communication control unit 2153. These respective functions are realized by the hardware operations of the respective blocks shown in FIG. 27 or by the microcomputer 1111 executing a predetermined program.

The system control unit 2131 controls the overall operation of the VPN device 2101.

The identification information management unit 2132 manages the identification information stored in the identification information storage unit 2133. Moreover, the identification information management unit 2132 can acquire the identification information of the transmission source terminal 103 and the transmission destination terminal 303 recognized by the message analyzing unit 2141 from the identification information storage unit 2133.

The identification information storage unit 2133 stores the identification information of the terminals 103 and 303. The identification information may be acquired from the call control server 202 or other servers and may be stored in advance rather than storing the same in advance in the identification information storage unit 2133. Moreover, when a message is received by the reception unit 2151 or 2154, and the identification information is included in the message, the identification information may be used. The priority when initiating a session is determined by the identification information.

In the fourth embodiment, for example, the MAC address, IP address, ID information, and telephone number of the terminals 103 and 303 are used as the identification information. When such identification information expressed by numeric and alphabetic codes is used, priority determination is facilitated by performing a sequential operation and addition and subtraction.

The message analyzing unit 2141 analyzes call information from the terminal 103 received by the reception unit 2151 and recognizes the terminal 103 as a transmission source and the terminal 303 as a transmission destination. The call information includes specific information for specifying the transmission source and transmission destination terminals. Moreover, the message analyzing unit 2141 analyzes a call control message received by the reception unit 2154.

Since each of the terminals 103 and 303 does not recognize the system configuration of FIG. 26, the terminals transmit a trigger noticing a call to the VPN devices 2101 and 2301. The trigger will be collectively referred to as call information. In this case, information for specifying the respective terminals 103 and 303 will be collectively referred to as specific information. Since the VPN devices 2101 and 2301 recognize the system configuration, the VPN devices generate a call message from the call information and convert the specific information into identification information. Moreover, each of the terminals 103 and 303 does not have call-receipt information because they receive data through the VPN devices.

Moreover, as the result of message analysis, when it is determined that a call request message is received by the reception unit 2154 after a call message is transmitted by the transmission unit 2155, the message analyzing unit 2141 determines the receive call request message to be invalid and disregards the call request message.

The priority determination unit 2142 determines which one of the terminals 103 and 303 has higher priority in accordance with the message analysis result and the identification information of the terminals 103 and 303 acquired from the identification information management unit 2132. For example, when the call information from the terminal 103 is received by the reception unit 2151, the priority determination unit 2142 acquires the identification information of the terminals 103 and 303 from the call information, the identification information storage unit 2133, or an external server. Moreover, the priority determination unit 2142 compares the acquired identification information of both terminals to determine priority.

The priority can be determined by the magnitude of the identification information, for example, and one of which the MAC address or other identification ID has a greater value can be determined to have higher priority, for example. Moreover, a unique priority order managed by a system may be determined in advance, and the priority may be determined based on the priority order of VIP customers, the job level of employees, and the priority order of networks, for example. Moreover, the priority may be determined so as to be favorable for processing of the algorithms.

Moreover, when the message analyzing unit 2141 determines that the call message or the call request message has been received, the message analyzing unit 2141 analyzes the received message from the terminal 303, and the priority determination unit 2142 determines the priority between the tr 303 as the transmission source and the terminal 103 as the transmission destination in accordance with the extracted identification information and determines the appropriateness of the type of the message (whether it is a call message or a call request message). For example, the priority determination unit 2142 determines that the terminal 303 has higher priority among the terminals 103 and 303 if a call message is received by the reception unit 2154 and determines that the terminal 103 has higher priority if a call request message is received by the reception unit 2154.

The message generation unit 2143 designates the type of a message relating to call control in accordance with the determination result by the priority determination unit 2142 and generates the call message or the call request message as the message. Specifically, the message generation unit 2143 generates the call request message when the terminal 303 has higher priority than the terminal 103 and generates the call message when the terminal 303 has lower priority than the terminal 103. Moreover, when a call-receipt (call acknowledgement) message is received by the reception unit 2154, the message generation unit 2143 generates a call-receipt acknowledgement message.

The reception unit 2151 receives a message relating to call control and actual data such as voice from the terminal 103.

The transmission unit 2152 transmits a message relating to call control and actual data such as voice to the terminal 103.

The reception units 2151 and 2154 receive messages relating to call control such as the call message, the call request message, the call-receipt message, or the call-receipt acknowledgement message, actual data, and the like from the terminals 103 and 303, respectively. Regarding the messages received by the reception units 2151 and 2154, the call message corresponds to the INVITE message, the call-receipt message corresponds to the ACK message, and the call-receipt acknowledgement message corresponds to the OK message.

The transmission units 2152 and 2155 transmit messages relating to call control such as the call message, the call request message, the call-receipt message, or the call-receipt acknowledgement message, actual data, and the like to the terminals 103 and 303, respectively.

The data communication control unit 2153 relays actual data between the reception unit 2151 and the transmission unit 2155, and relays actual data between the reception unit 2154 and the transmission unit 2152.

The configuration I/F unit 2161 is a user interface for allowing a user or an administrator to perform operations on the VPN device 2101, and a Web page or the like is used, for example.

The subordinate terminal management unit 2162 manages the terminals 103 under the VPN device 2101.

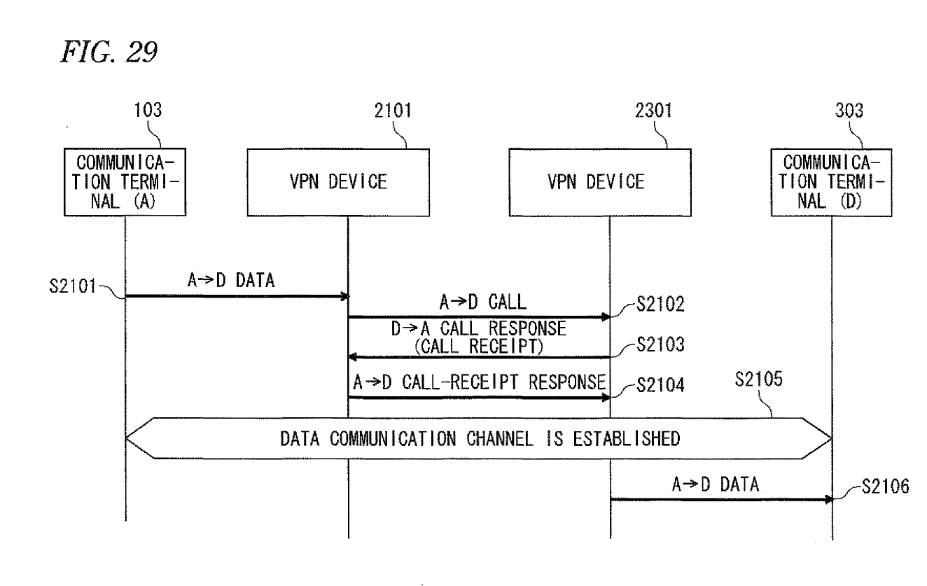

Next, transmission and reception of data when the terminals 103 and 303 initiate a session will be described. In FIGS. 29 to 31, it is assumed that the priority of the terminal 103 is higher than the priority of the terminal 303. Initiation of a session is performed, and when processed normally, the session is established.

FIG. 29 is a diagram showing an example of a communication procedure when the terminal 103 makes a call to the terminal 303.

First, the terminal 103 transmits call information for transmitting is data to the terminal 303 to the VPN device 2101 that manages the terminal 103 (step S2101). Upon receiving the call information from the terminal 103, the VPN device 2101 transmits a call message to the VPN device 2301 that manages the terminal 303 since the terminal 103 has higher priority (step S2102).

Upon receiving the call message from the VPN device 2101, the VPN device 2301 transmits a call-receipt message in response thereto to the VPN device 2101 (step S2103). Upon receiving the call-receipt message from the VPN device 2301, the VPN device 2101 transmits a call-receipt acknowledgement message in response thereto to the VPN device 2301 (step S2104).

When the VPN device 2301 receives the call-receipt acknowledgement message from the VPN device 2101, a session is established between the VPN device 2101 and the subordinate terminal 103, and the VPN device 2301 and the subordinate terminal 303 (step S2105). After the session is established, data transmitted from the terminal 103 is transmitted to the terminal 303 through the VPN devices 2101 and 2301 (step S2106).

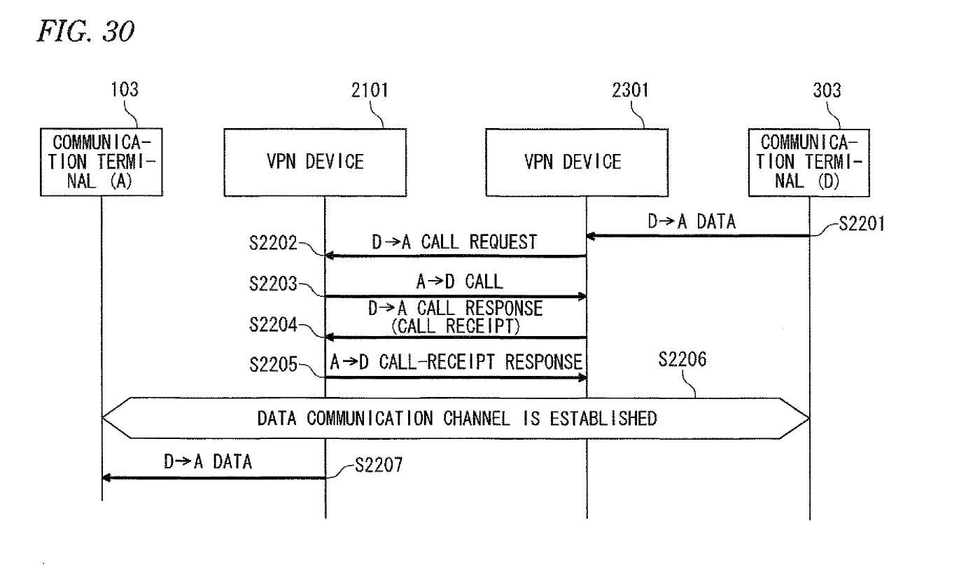

Moreover, FIG. 30 is a diagram showing an example of a communication procedure when the terminal 303 makes a call to the terminal 103.

First, the terminal 303 transmits call information for transmitting data to the terminal 103 to the VPN device 2301 that manages the terminal 303 (step S2201). Upon receiving the call information from the terminal 303, the VPN device 2301 transmits a call request message to the VPN device 2101 that manages the terminal 103 since the terminal 303 has lower priority (step S2202).

Upon receiving the call request message from the VPN device 2301, the VPN device 2101 transmits a call message in response thereto to the VPN device 2301 (step S2203). Upon receiving the call message from the VPN device 2101, the VPN device 2301 transmits a call-receipt message in response thereto to the VPN device 2101 (step S2204). Upon receiving the call-receipt message from the VPN device 2301, the VPN device 2101 transmits a call-receipt acknowledgement message in response thereto to the VPN device 2301 (step S2205).

When the VPN device 2301 receives the call-receipt acknowledgement message from the VPN device 2101, a session is established between the VPN device 2101 and the subordinate terminal 103, and the VPN device 2301 and the subordinate terminal 303 (step S2206). After the session is established, data transmitted from the terminal 303 is transmitted to the terminal 103 through the VPN devices 2301 and 2101 (step S2207).

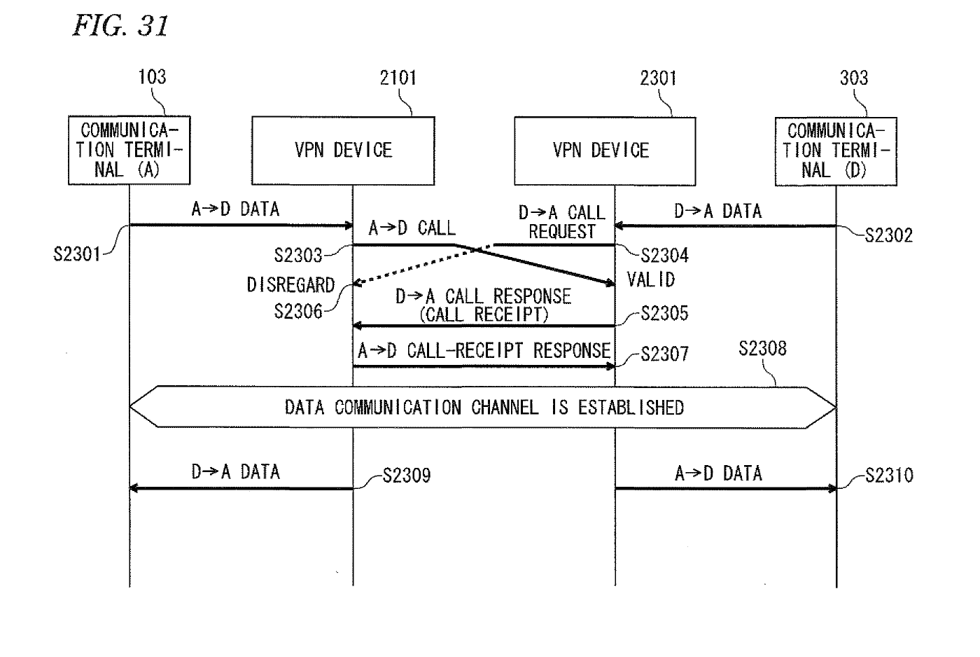

Moreover, FIG. 31 is a diagram showing an example of a communication procedure when a call from the terminal 103 to the terminal 303 occurs simultaneously with a call from the terminal 303 to the terminal 103.

First, the terminal 103 transmits call information for transmitting data to the terminal 303 to the VPN device 2301 that manages the terminal 103 (step S2301), and the terminal 303 transmits call information for transmitting data to the terminal 103 to the VPN device 2301 that manages the terminal 303 (step S2302).

Upon receiving the call information from the terminal 103, the VPN device 2101 transmits a call message to the VPN device 2301. (step S2303). Upon receiving the call information from the terminal 303, the VPN device 2301 transmits a call request message to the VPN device 2101 (step S2304).

Uₚon receiving the call message from the VPN device 2101, the VPN device 2301 transmits a call-receipt message in response thereto to the VPN device 2101 (step S2305). On the other hand, upon receiving the call request message from the VPN device 2301 after transmitting the call message and before receiving the call-receipt message, the VPN device 2101 disregards this message (step S2306). That is, the VPN device 2101 discards the received call request message and stops transmitting the call message in response thereto.

Upon receiving the call-receipt message from the VPN device 2301, the VPN device 2101 transmits a call-receipt acknowledgement message in response thereto to the VPN device 2301 (step S2307). When the VPN device 2301 receives the call-receipt acknowledgement message from the VPN device 2101, a session is established between the VPN device 2101 and the subordinate terminal 103, and the VPN device 2301 and the subordinate terminal 303 (step S2308).

After the session is established, when the terminal 103 checks the call-receipt information to permit a response to the call from the terminal 303, data transmitted from the terminal 303 is transmitted to the terminal 103 through the VPN devices 2301 and 2101 (step S2309). Moreover, after the session is established, data transmitted from the terminal 103 is transmitted to the terminal 303 through the VPN devices 2101 and 2301 (step S2310).

Next, the operation when the VPN device relays communication between terminals will be described.

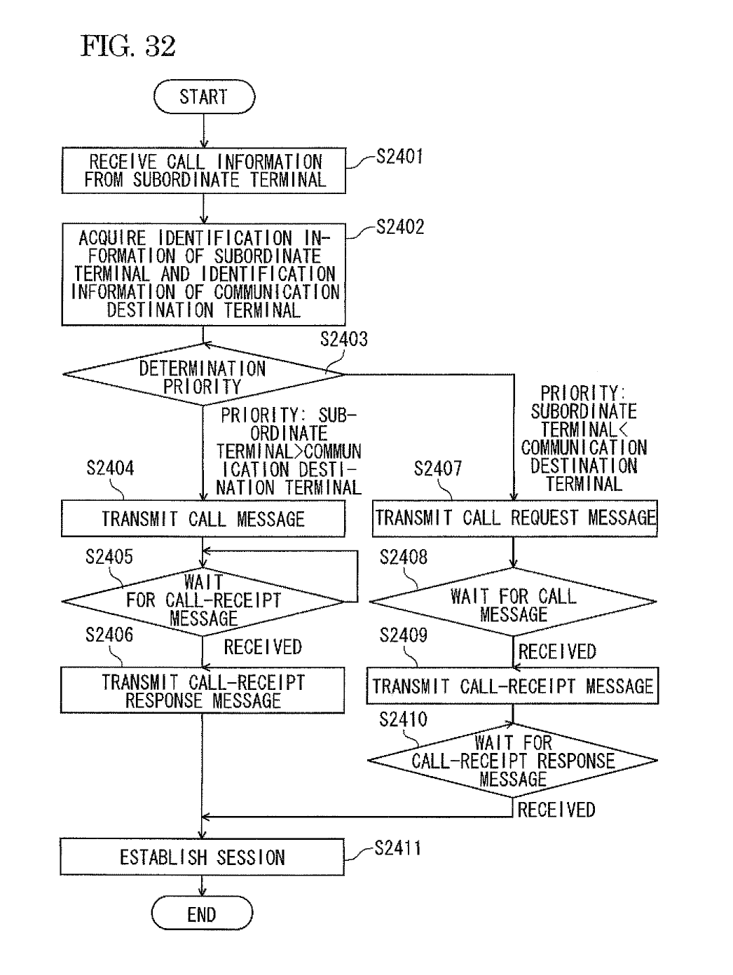

FIG. 32 is a flowchart showing an example of the operation when the VPN device 2101 relays communication between the subordinate terminal 103 and the communication destination terminal 303. The same operation is performed by the VPN device 2301.

First, when the reception unit 2151 receives the call information from the subordinate terminal 103 (step S2401), the message analyzing unit 2141 extracts the specific information specifying the terminal 103 and the specific information specifying the terminal 303 from the received call information. Moreover, the priority determination unit 2142 acquires an identification number as the identification information of the terminal 103 and an identification number as the identification information of the terminal 303 corresponding to the specific information from the identification information storage unit 2133, an external server, or the like (step S2402). Moreover, the specific information may be the identification information itself.

Subsequently, the priority determination unit 2142 determines the priority of the terminals 103 and 303 based on the acquired identification numbers of the terminals 103 and 303 (step S2403). For example, if the identification ID of the terminal 103 is “1234” and the identification ID of the terminal 303 is “5678,” it can be determined that the terminal 103 has low priority, and the terminal 303 has high priority.

When the priority of the terminal 103 is higher than the priority of the terminal 303, the message generation unit 2143 generates a call message and the transmission unit 2155 transmits the generated call message (step S2404).

Subsequently, the reception unit 2154 performs standby until it receives a call-receipt message from the terminal 303 in response to the call message transmitted by the transmission unit 2155 (step S2405). When the reception unit 2154 receives the call-receipt message, the message generation unit 2143 generates a call-receipt acknowledgement message, and the transmission unit 2155 transmits the generated call-receipt acknowledgement message (step S2406).

On the other hand, when it is determined in step S2403 that the priority of the terminal 103 is lower than the priority of the terminal 303, the message generation unit 2143 generates a call request message and the transmission unit 2155 transmits the generated call request message (step S2407).

Subsequently, the reception unit 2154 performs standby until it receives a call message from the terminal 303 in response to the call request message transmitted by the transmission unit 2155 (step S2408). When the reception unit 2154 receives the call message, the message generation unit 2143 generates a call-receipt message, and the transmission unit 2155 transmits the generated call-receipt message (step S2409).

Subsequently, the reception unit 2154 performs standby until it receives a call-receipt acknowledgement message from the terminal 303 in response to the call-receipt message transmitted by the transmission unit 2155 (step S2410). When the reception unit 2154 receives the call-receipt acknowledgement message, a session is established between the terminals 101 and 303, and a state where communication can be performed between both terminals is created (step S2411).

According to the communication system of the present embodiment, by introducing a priority relationship into the power when initiating a session, it is possible to prevent the occurrence of cross calls. Specifically, the power to make a call is assigned to only a terminal having higher priority, and only the power to requesting for a call is assigned to terminals having lower priority. Moreover, a call message is transmitted when data is transmitted from a terminal having higher priority, and a call request message is transmitted when data is transmitted from terminals having lower priority, whereby it is possible to prevent malfunctions due to the occurrence of cross calls. Moreover, when data is transmitted simultaneously between a plurality of terminals, a terminal having higher priority disregards a call request message from terminals having lower priority, whereby a state where terminals wanting to make a call are engaged in communication (for example, busy state) can be obviated, and a session can be established smoothly. In addition, since the VPN devices 2101 and 2301 perform the process of preventing cross calls, there is no increase in the load of the terminals 103 and 303 which are the transmission source and transmission destination.

In the present embodiment, although since in many cases, VPN communication is generally performed to enhance security, the VPN device has been described, it is not essential to perform VPN communication. That is, the VPN devices 2101 and 2301 may be substituted with pure relay devices. In addition, when it is not necessary to traverse the NAT (Network Address Translation), for example, when all devices in a system are assigned with global addresses, the STUN server 201 may be omitted.

### Fifth Embodiment

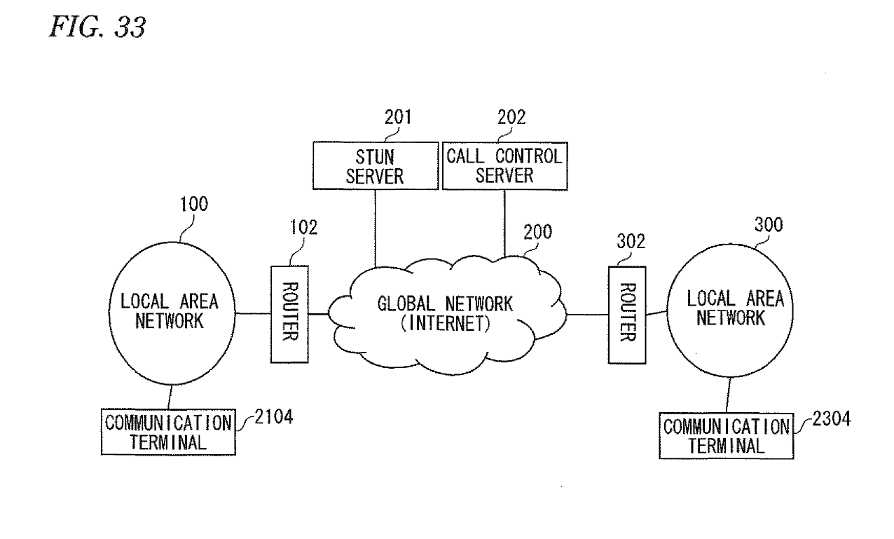

FIG. 33 is a diagram showing an example of a configuration of a communication system according to the fifth embodiment of the invention. In this example, in the communication system shown in FIG. 33, the same configurations as the communication system shown in FIG. 26 will be denoted by the same reference numerals, and description thereof will be omitted or simplified.

The difference between the communication system of the present embodiment and the communication system of the fourth embodiment lies in the subordinate portions of the local area networks 100 and 300. Specifically, the VPN device 2101 and terminals 103 and the VPN device 2301 and terminals 303 shown in FIG. 26 are substituted with only terminals 2104 and 2304 in the example shown in FIG. 33. The terminals 2104 and 2304 are configured to have the functions of the VPN device 2101 and terminals 103 and the VPN device 2301 and terminals 303. That is, the terminal 2104 is managed by the terminal 2104 itself. The terminals 2104 and 2304 function as the peers of P2P communication.

Next, the terminals 2104 and 2304 will be described.

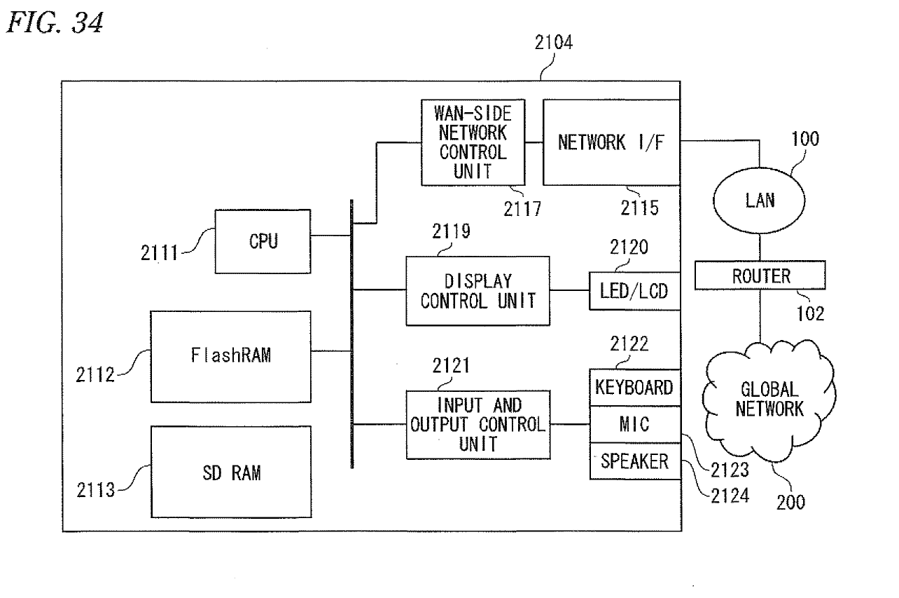

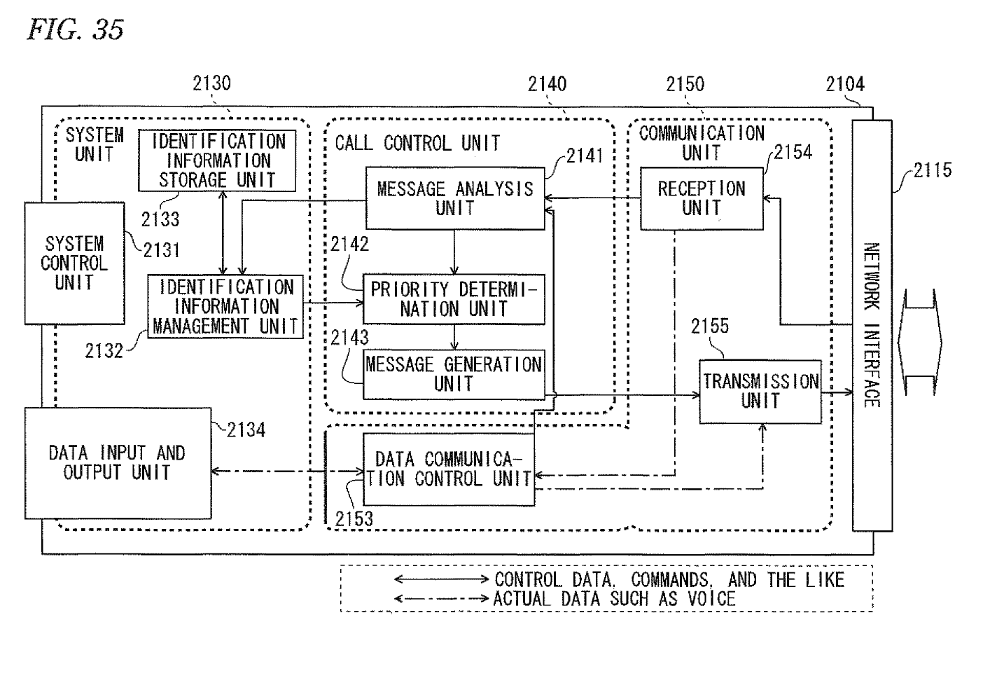

The configuration and operation of the terminals 2104 and 2304 are the same. In this example, the terminal 2104 will be described. FIG. 34 is a diagram showing an example of a hardware configuration of the terminal 2104, and FIG. 35 is a diagram showing an example of a functional configuration of the terminal 2104. In FIG. 34, the same configurations as the hardware configuration shown in FIG. 27 will be denoted by the same reference numeral, and description thereof will be omitted or simplified. Moreover, in FIG. 35, the same configurations as the function configuration shown in FIG. 28 will be denoted by the same reference numeral, and description thereof will be omitted or simplified.

As a hardware configuration, as shown in FIG. 34, the terminal 2104 includes a CPU 2111, a nonvolatile RAM (flash RAM) 2112, a memory (SD RAM) 2113, a network interface (I/F) 2115, a network control unit 2117, a display control unit 2119, a display 2120, an input and output control unit 2121, a keypad 2122, a microphone (Mic) 2123, and a speaker 2124. That is, in the terminal 2104 of the fourth embodiment, the configuration for relaying data to subordinate terminals is not present, and a configuration for inputting and outputting data is added as compared to the VPN device 2101 of the fourth embodiment.

The input and output control unit 2121 performs input and output control of the keypad 2122, the microphone 2123, and the speaker 2124 which are used as input and output devices. The keypad 2122 is an input device for inputting data. The microphone 2123 is an input device for inputting voice data. The speaker 2124 is an output device for outputting voice data.

Moreover, as a functional configuration, as shown in FIG. 35, a system unit 2130, a call control unit 2140, and a communication unit 2150 are provided. The system unit 2130 includes a system control unit 2131, an identification information management unit 2132, an identification information storage unit 2133, and a data input and output unit 2134. The call control unit 2140 includes a message analyzing unit 2141, a priority determination unit 2142, and a message generation unit 2143. The communication unit 2150 includes a data communication control unit 2153, a reception unit 2154, and a transmission unit 2155. In addition, from the reason described above, the terminal 104 does not include the reception unit 2151, the transmission unit 2152, the configuration I/F unit 2161, and the subordinate terminal management unit 2162.

The data input and output unit 2134 generates call information based on the data input by the input device and transmits the call information to the message analyzing unit 2141.

Next, transmission and reception of data when the terminals 2104 and 2304 initiate a session will he described.

Basically, the same operation as the operation of the VPN devices 2101 and 2301 shown. in FIGS. 29 to 31 is performed. The fifth embodiment is characterized in that the terminals 2104 and 2304 generation call information based on the input of the input devices of the terminals 2104 and 2304 themselves to initiate a session rather than receiving the call information from the terminals to initiate a session. Moreover, the determination as to whether a call will be permitted or not based on the call-receipt information is performed by the terminals 2104 and 2304 themselves rather than by the subordinate terminals.

Next, the operation when the terminal 2104 initiates a session will be described.

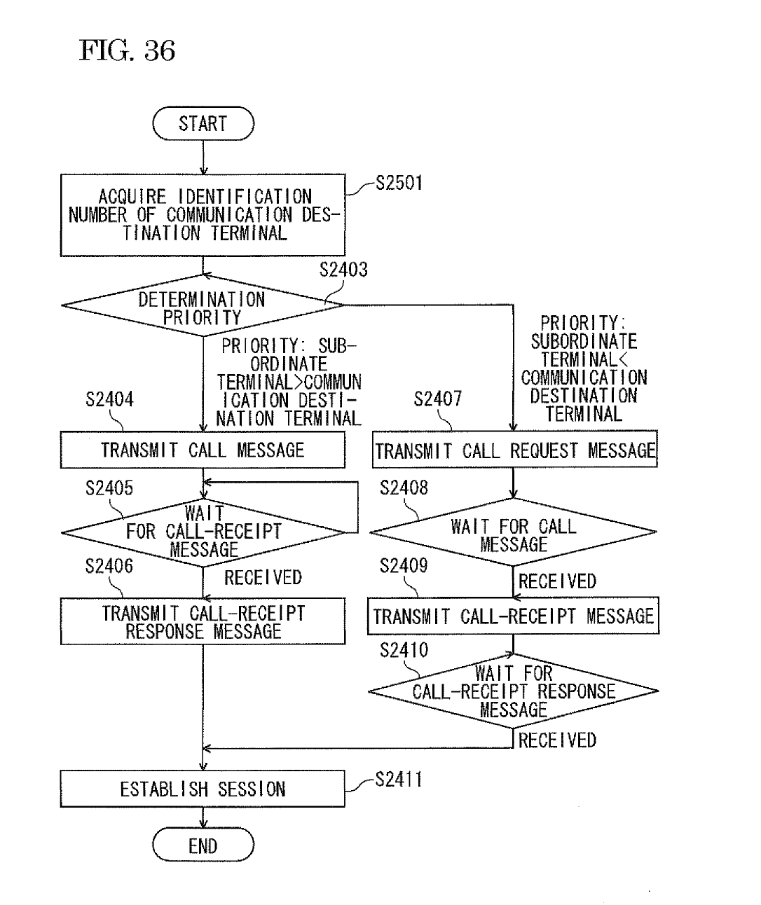

FIG. 36 is a flowchart showing an example of the operation when the terminal 2104 initiates a session. The terminal 2304 performs the same operation.

First, when the data communication control unit 2153 generates call information based on the input by the data input and output unit 2134, the message analyzing unit 2141 extracts specific information specifying the terminal 2304 from the generated call information. Moreover, the priority determination unit 2142 acquires an identification number as the identification information of the terminal 2304 corresponding to the specific information from the identification information storage unit 2133, an external server, a call message, a call request message, or the like (step S2501). Moreover, the specific information may be the identification information itself. Moreover, an identification number of the identification information of the terminal 2104 itself is acquired from the identification information storage unit 2133, an external server, a call message, a call request message, or the like.

Subsequent to step S2501, the same processes as steps 52403 to S2411 shown in FIG. 32 are performed. The step numbers in FIG. 36 are denoted by the same numbers as FIG. 32, and redundant description thereof is omitted. However, the comparison subjects of the priority are the terminal 2104 which is the subject communication terminal and the terminal 2304 which is a destination communication terminal.

According to the communication system of the present embodiment, since the priority relationship in initiation of a session is determined when a counterpart of P2P communication is designated, it is possible to prevent the occurrence of cross calls. Therefore, it is not necessary to prepare a special canceling means to handle the occurrence of cross calls. Moreover, the user does not need to pay special attention to the occurrence of cross calls.

Moreover, since no cross call occurs, the P2P communication can be initiated quickly, and a smooth P2P communication environment can be provided. Furthermore, since a special relay device for preventing cross calls is not provided, it is possible to prevent the configuration of the communication system from becoming complex.

### Sixth Embodiment

In the fourth and fifth embodiments, priority is determined in advance before a cross call occurs to thereby prevent the occurrence of cross calls. However, the communication system of the sixth embodiment is characterized in that the occurrence of a cross call is detected, and control is performed based on priority after the detection. In the sixth embodiment, although the subject that performs the characteristic process may be both the VPN device shown in the fourth embodiment and the terminal shown in the fifth embodiment, in this example, the subject will be described as a “communication device.”

The configuration of the communication system, the hardware configuration of the communication device, the functional configuration of the communication device in the sixth embodiment are the same as the configurations shown the fourth or fifth embodiment, except for the operation of the message analyzing unit 2141.

The message analyzing unit 2141 monitors whether the sequence of messages relating the call control follows in accordance with the 3WHS in addition to the operation described in the fourth or fifth embodiment. For example, if a call message is received from a destination communication device when the transmission unit 2155 transmits a call message and waits for a call-receipt message, the message analyzing unit 2141 determines that a cross call occurs.

Communication devices being engaged in communication recognize the identification information of the communication counterparts as described above in the fourth and fifth embodiments. Thus, the message analyzing unit 2141 can determine whether a call message is received from a communication counterpart to which the call message has already been transmitted, namely whether a cross call has occurred by analyzing the content of a message to acquire the identification information of a communication counterpart.

When the message analyzing unit 2141 determines that the cross call has occurred, the priority determination unit 2142 determines priority based on the identification information of the subject communication device and the identification information of the destination communication device. Moreover, a communication device having higher priority determines that the received call message is not valid and disregards the message, and the processes subsequent to step S2306 shown in FIG. 31 are performed. On the other hand, a communication device having lower priority determines that the received call message is valid, and the processes subsequent to step S2305 shown in FIG. 31 are performed.

In the fourth to sixth embodiments described above, it has been described that the priority determination unit 2142 performs one specific determination process. However, the invention is not limited to this. For example, the priority determination unit 2142 may be configured to take a plurality of determination processes, and may perform any one of the determination processes in accordance with the time of day, a date, the day of a week, and the type of LAN 100 and WAN 200. Accordingly, it is possible to provide a communication terminal and a communication method adapted to various uses such as for use in weekdays or holidays, for example.

According to the communication system of the fourth to sixth embodiments, it is possible to recover the sequence of messages after a cross call occurs and to eliminate situations where it is unable to establish a session due to the cross call. Moreover, since the process for preventing cross calls is not performed whenever initiating a session, it is possible to realize the communication system with a low processing load. Furthermore, since the priority relationship is determined as necessary only, it is possible to shorten the time needed to initiate P2P communication.

While the invention has been described in detail and with reference to specific embodiments, it is obvious to those skilled in the art that the invention can be changed and modified in various ways without departing from the spirit and scope of the invention.

This application is based upon the benefit of priority from Japanese

Patent Application No. 2009-099965 filed on Apr. 16, 2009, Japanese Patent Application No. 2009-102108 filed on Apr. 20, 2009, and Japanese Patent Application Nos. 2009-137423 and 2009-137424 filed on Jun. 8, 2009, the entire contents of which are incorporated herein by reference.

### INDUSTRIAL APPLICABILITY

The invention is ideally used in VPN devices or the like capable of eliminating situations where cross calls occur.

### REFERENCE SIGNS LIST

100, 300: LAN (LOCAL AREA NETWORK)

101, 104, 301, 304, 1101, 1104, 1301, 2101, 2301: VPN DEVICE

102, 302: ROUTER

103, 105, 303, 2104, 2304: TERMINAL

111, 1111, 2111: CPU

112, 1112, 2112: NONVOLATILE MEMORY (FLASHRAM)

113, 1113, 2113: MEMORY (SD RAM)

114, 115, 1114, 1115, 2114, 2115: NETWORK INTERFACE (NETWORK I/F)

116, 1116, 2116: LAN-SIDE NETWORK CONTROL UNIT

117, 1117, 2117: WAN-SIDE NETWORK CONTROL UNIT

118, 1118, 2118: COMMUNICATION RELAY UNIT

119, 1119, 2119: DISPLAY CONTROL UNIT

120, 1120: DISPLAY UNIT

130, 1130: SYSTEM CONTROL UNIT

131, 1131, 2162: SUBORDINATE TERMINAL MANAGEMENT UNIT

132, 1132: MEMORY UNIT

133, 1133: DATA RELAY UNIT

134, 1134, 2161: CONFIGURATION INTERFACE UNIT (CONFIGURATION I/F UNIT)

135, 1135: EXTERNAL ADDRESS AND PORT INFORMATION STORAGE UNIT

1136: COMMUNICATION CHANNEL INFORMATION STORAGE UNIT

136: VOIP APPLICATION FUNCTIONAL UNIT

137: VOICE DATA CONTROL UNIT

138: DATA INPUT AND OUTPUT UNIT

140, 1140: COMMUNICATION UNIT

141, 1141: EXTERNAL ADDRESS AND PORT ACQUISITION UNIT

142, 1142: VPN FUNCTIONAL UNIT

143, 1143: CALL CONTROL FUNCTIONAL UNIT

145, 1145: ENCRYPTION PROCESSING UNIT

200: WAN (GLOBAL NETWORK)

201: STUN SERVER

202: CALL CONTROL SERVER

203: DATA COMMUNICATION RELAY SERVER

204: ATTRIBUTE INFORMATION SERVER

2120: DISPLAY (LED/LCD)

2121: INPUT AND OUTPUT CONTROL UNIT

2122: KEYPAD

2123: MIC (MICROPHONE)

2124: SPEAKER

2130: SYSTEM UNIT

2131: SYSTEM CONTROL UNIT

2132: IDENTIFICATION INFORMATION MANAGEMENT UNIT

2133: IDENTIFICATION INFORMATION STORAGE UNIT

2134: DATA INPUT AND OUTPUT UNIT

2140: CALL CONTROL UNIT

2141: MESSAGE ANALYZING UNIT

2142: PRIORITY DETERMINATION UNIT

2143: MESSAGE GENERATION UNIT

2150: COMMUNICATION UNIT

2151, 2154: RECEPTION UNIT

2152, 2155: TRANSMISSION UNIT

2153: DATA COMMUNICATION CONTROL UNIT

1: A VPN device to be provided on a first network for performing a P2P communication between a first terminal provided on the first network and a second terminal provided on a second network connected to the first network, the VPN device comprising:
a priority determination unit that determines which one of the first terminal and the second terminal has a higher priority of a call; and
a transmission unit that transmits a call message to the second network to call the second terminal when the priority determination unit has determined that the first terminal has the higher priority than the second terminal, and that transmits a call request message to the second network to request a call from the second terminal when the priority determination unit has determined that the second terminal has the higher priority than the first terminal.

2: The VPN device according to claim 1, comprising:
a reception unit that receives call-receipt message from the second network in response to the call message that has been transmitted by the transmission unit, wherein
the transmission unit is not allowed to retransmit a call message to the second network even if the reception unit receives a call request message from the second network until the reception unit receives the call-receipt message from the second network after the transmission unit has transmitted the call message to the second network.

3: The VPN device according to claim 1, wherein the priority determination unit determines which one of the first terminal and the second terminal has the higher priority of the call from identification information of the first terminal and the second terminal.

4: The VPN device according to claim 3, wherein the identification information is a MAC address.

5: The VPN device according to claim 3, wherein the identification information is an IP address.

6: The VPN device according to claim 3, wherein the identification information is an ID information.

7: The VPN device according to claim 3, wherein the identification information is a telephone number.

8: The VPN device according to claim 1, comprising:
an external address and port information acquisition unit that acquires external address and port information of the first terminal which is accessible from the second network;
an external address and port information transmission unit that transmits the external address and port information of the first terminal acquired by the external address and port information acquisition unit to the second network;
an external address and port information reception unit that receives, from the second network, external address and port information of the second terminal which is accessible from the first network; and
a network P2P communication unit that enables the P2P communication between the first terminal and the second terminal with reference to the external address and port information of the second terminal received by the external address and port information reception unit.

9: The VPN device according to claim 8, wherein the first network and the second network are connected via a third network.

10: The VPN device according to claim 9, comprising
a communication-through-relay-server unit that enables a communication through relay server between the first terminal and the second terminal through a relay server provided on the third network before the network P2P communication enables the P2P communication between the first terminal and the second terminal.

11: The VPN device according to claim 10, wherein the external address and port information transmission unit transmits the external address and port information of the first terminal to the second network through the relay server.

12: The VPN device according to claim 9, wherein the first network and the second network are local networks, and the third network is a global network.

13: The VPN device according to claim 12, wherein the external address and port information of the first terminal includes a global IP address and a port number of the first terminal.

14: The VPN device according to claim 9, wherein the external address and port information acquisition unit acquires the external address and port information of the first terminal from an address information server provided on the third network.

15: The VPN device according to claim 9, comprising:
a determination unit that determines whether the second network is the same as the first network; and
a local P2P communication unit that enables the P2P communication between the first terminal and the second terminal without the third network with reference to internal address and port information of the first terminal accessible within the first network when the determination unit has determined that the second network is the same as the first network.

16: A VPN networking method of a VPN device to be provided on a first network for performing a P2P communication between a first terminal provided on the first network and a second terminal provided on a second network connected to the first network, the VPN networking method comprising the steps of:
determining which one of the first terminal and the second terminal has a higher priority of a call;
transmitting a call message to the second network to call the second terminal when it is determined that the first terminal has the higher priority than the second terminal; and
transmitting a call request message to the second network to request a call from the second terminal when it is determined that the second terminal has the higher priority than the first terminal.

17: The VPN networking method according to claim 16, comprising a step of:
receiving call-receipt message from the second network in response to the transmitted call message, wherein
a call message to the second network is not retransmitted even if a call request message is received from the second network until the call-receipt message is received from the second network after the call message has been transmitted to the second network.

18: The VPN networking method according to claim 16, comprising the steps of:
acquiring external address and port information of the first terminal which is accessible from the second network;
transmitting the acquired external address and port information of the first terminal to the second network;
receiving, from the second network, external address and port information of the second terminal which is accessible from the first network; and
enabling the P2P communication between the first terminal and the second terminal with reference to the received external address and port information of the second terminal.

19: The VPN networking method according to claim 19, wherein
the first network and the second network are connected via a third network, and
the VPN networking method comprises a step of enabling a communication through relay server between the first terminal and the second terminal through a relay server provided on the third network before the P2P communication between the first terminal and the second terminal is enabled.

20: The VPN networking method according to claim 18, comprising the steps of:
determining whether the second network is the same as the first network; and
enabling the P2P communication between the first terminal and the second terminal without the third network with reference to internal address and port information of the first terminal accessible within the first network when it is determined that the second network is the same as the first network.
